(19) United States
(12) Patent Application Publication
(10) Pub. No.: US 2026/0311037 A1
(43) Pub. Date: Oct. 8, 2026

(54) SYSTEMS AND METHODS FOR INTERCEPTING AND MODIFYING INFERENCING OF MACHINE LEARNING MODELS

(71) Applicant: Adeia Guides Inc., San Jose, CA (US)

(72) Inventors: Serhad Doken, Bryn Mawr, PA (US); Charles Dasher, Lawrenceville, GA (US)

(21) Appl. No.: 19/170,804

(22) Filed: Apr. 4, 2025

(51) Int. Cl. G06N 20/00

(52) U.S. Cl. CPC G06N 20/00

(57) ABSTRACT

Systems and methods are disclosed for modifying inferencing of machine learning (ML) models. Based on a first input and session context data, an ML model may generate a first plurality of output tokens. Based on supplemental context data, a first one or more tokens from the first plurality of output tokens may be identified. A second input may be generated based on the identified first one or more tokens, the supplemental context data, or both. The second input may be provided to the ML model. Based on the second input, session context data, supplemental context data, or a combination thereof, the ML model may generate a second plurality of output tokens. In response to the first input and the second input, an output based on the first plurality of tokens, the second plurality of tokens, and supplemental context data may be provided.

### BACKGROUND

This disclosure relates to intercepting and modifying inferencing of machine learning (IL) models, such as in the context of agentic workflows.

### SUMMARY

The use of machine learning (ML) models, such as large language models (LLMs), is ever increasing. A user may interface with ML models (e.g., by way of an application programming interface (API) or an artificial intelligence (AI) agent) for various applications, such as customer service and support, content creation, or coding assistance. AI agents may also interface with ML models and integrate ML model responses into agentic workflows of the AI agent. For example, the AI agent (or a user via the AI agent) may interact with the ML model during a session (e.g., inferencing session), which may be an instance between the AI agent and the ML model where the AI agent provides the ML model with one or more inputs and the ML model responds with one or more outputs based on performing inferencing based on the input(s). For example, the ML model may make predictions, answer queries, solve a problem, or generate other suitable output, based on the input. For instance, an ML model, such as an LLM, may receive a prompt from a user or AI agent and perform inferencing, whereby the LLM makes predictions, draw conclusions, generates new data or other relevant outputs, from the input prompt, based on the patterns learned by the LLM. Outputs from LLM inferencing may include human-like or conversational responses. However, LLMs can at times produce hallucinations (e.g., inaccurate or misleading information). Hallucinations can cause various issues for the user or AI agent, such as providing incorrect information to the user and therefore negatively impacting the user's application, disrupting agentic workflow of an AI agent and causing agentic workflow failures or execution of unintended actions, or quickly cascading into further hallucinations as LLM inferencing continues on erroneous data. Moreover, LLMs are not inherently capable of analyzing text subjectively (e.g., as an abstract string). In order for the LLM to understand text, it objectively reads the contents of the text, resulting in declining efficiency of the LLM as input data to the LLM grows in size. Therefore, improved techniques for fine-tuning an LLM to learn to handle tasks involving subjective judgment or ambiguity, and to prevent or reduce LLM hallucinations are desired.

In one approach, supervised fine-tuning may be used to improve performance of an LLM. However, supervised fine-tuning may rely on static datasets that can often be limited in scope, context, or diversity. A supervised fine-tuning model is susceptible to failing to recognize humane contextual considerations (e.g., human values, ethics, social norms, or other suitable tasks that involve subjective judgment or ambiguity), resulting in the model favoring an answer that is based on the training data but that may be inappropriate in a certain context.

In another approach, reinforcement learning from human feedback (RLHF) may be implemented to fine-tune an LLM by integrating human judgment into the LLM training process. However, this approach may not be economically feasible because it requires finding and recruiting appropriate people to fine-tune the LLM. Recruitment for RLHF and the collection of human feedback may also be difficult to perform at scale. Moreover, RLHF is limited in the ability to provide a way to edit the LLM output with granularity, and therefore may generally fail to prevent hallucinations that may result from a granular detail in the LLM output.

In another approach, a Tree of Thought (ToT) framework may be implemented to fine-tune an LLM by guiding the LLM through a series of reasoning steps, where each step can branch into multiple paths and allow the LLM to evaluate alternative strategies. However, ToT also is limited in the ability edit an LLM output with granularity, and is therefore generally unable to prevent hallucinations that may result from a granular detail in the LLM output.

In yet another approach, a user or AI agent may directly edit LLM output. During a session with the LLM, the user or AI agent may edit LLM outputs that are non-hallucinations, to proactively reduce the risk of future hallucinations. The session may be associated with session context data (e.g., context data or context window), which may include information that the LLM considers or is aware of during the inferencing session. The user or AI agent may also correct LLM outputs that are hallucinations, thereby redirecting the LLM inferencing in the correct path. However, directly editing the LLM output may involve issuing a new prompt to the LLM, which often requires the LLM to start over its session (e.g., discard context data and rebuild context data for the new session), despite the correction being directed to the same topic as the original session. Starting the LLM session over to fix an error in the LLM output is computationally inefficient and expensive.

To help address these problems, systems and methods are provided herein for improved techniques for intercepting and modifying ML model inferencing. In an embodiment, interception of the ML model may cause pausing of the inferencing process while maintaining the session context data. For example, when a user or AI agent intercepts inferencing, the session may be paused and the ML model may be instructed to maintain the session context data (for instance, refrain from discarding tokens or other context data associated with the session). During interception, the user or AI agent may request and receive or otherwise identify granular data or metadata that was used during the inferencing session. For instance, during interception, the AI agent may request data relating to the reasoning (e.g., rules, processes, metadata, weighting of such rules or processes, alternative responses that were considered for but were not output, any other suitable information, or a combination thereof) that the ML model applied during inferencing or in generating a particular output. Alternatively, or additionally, during interception, the ML model may await further input or modification (e.g., in-segment modification) of a particular segment (e.g., a portion or a state or any suitable part of the process of the inferencing session). The in-segment modification may cause the ML model to resume inferencing based on the modified segment and the preserved tokens for the remainder of the session.

In some embodiments, an ML model inferencing modification application (MIMA) is provided for receiving, from an ML model (such as an LLM), a first plurality of output tokens that were generated by the ML model based on a first input (e.g., provided by a user or AI agent), and session context data (e.g., context data associated with an LLM inferencing session for a given topic, task or query). In some embodiments, the AI agent comprises the MIMA. Based on supplemental context data, the MIMA may identify, from the first plurality of output tokens, a first one or more tokens to be modified. The MIMA may generate second input based at least in part on (a) the identified first one or more tokens, (b) the supplemental context data, or both. The second input may comprise a modification of at least a portion of the first input. The MIMA may provide, to the ML model, the second input. The MIMA may receive, from the ML model, a second plurality of output tokens that were generated by the ML model based at least in part on the second input, the session context data, the supplemental context data, or a combination thereof. The MIMA may provide for output a response to an initial query or request, which the first input and the second input relate to. In the present example, the response is based on a combination of the first plurality of output tokens, the second plurality of output tokens, and the supplemental context data.

In some examples, supplemental context (e.g., supplemental context data) may include any suitable data that is relevant to the session, is used to supplement the session (e.g., used to supplement the session context data), or both. For example, supplemental context data may include: one or more parameters associated with context data of the session; modification of the one or more parameters; inputs to or outputs from the ML model; one or more attributes associated with inputs to or outputs from ML model; modification of the one or more attributes; data associated with one or more users or user profiles; data associated with agentic workflow settings, rules, processes, conditions, and the like; user or other input to or output from agentic workflow; context data associated with one or more previous or other sessions between the ML model and a user (and/or an AI agent); context data associated with one or more sessions between an AI agent and a user; any other suitable data; or a combination thereof.

As an example, parameters of the context data may include any suitable one or more values, rule or rule set, conditions, or other suitable information, associated with defining the scope of the inferencing by the ML model. For example, where an input comprises “Who is the best soccer player right now?,” parameters may include defining the identification of the best soccer player by performance, statistics, skill set, top scores, number of games won, location, time frame, or other suitable information.

As an example, attributes of the inputs or outputs (e.g., text, tokens, or other suitable input or output data between the user or AI agent and the ML model) may include any suitable quality or characteristic, or other suitable information, associated with input or output, or portions thereof to and from the ML model. For example, an attribute may be certain terms or phrases (e.g., semantics, alternative words to the original word), tone, length, language style, audience, level of detail, or other suitable properties or characteristics of the input or output.

In some embodiments, the supplemental context data comprises one or more parameters associated with the inferencing session context data (e.g., context data), modification of the one or more parameters, one or more attributes associated with any one or more of the inputs or outputs (e.g., the first token or the first plurality of tokens), modification of the one or more attributes, data associated with one or more user profiles, user input, context data associated with one or more previous sessions, or a combination thereof. The one or more attributes may comprise terms or phrases, tone, length, language style, audience, level of detail, or a combination thereof.

In some embodiments, the ML model generates a plurality of candidate tokens based on the first input and the session context data. The plurality of candidate tokens may comprise the first one or more tokens and a plurality of alternate output tokens. The ML model may generate a plurality of logits corresponding to the plurality of candidate tokens based on the first input and the session context data. The ML model may identify a subset of logits of the plurality of logits. The ML model may determine the first one or more tokens and the plurality of alternate output tokens based on the identified subset of logits. The MIMA may request and receive, from the ML model, the plurality of alternate output tokens. The MIMA may select one or more alternate output tokens from the plurality of alternate output tokens based on the supplemental context data. The second input may further be based at least in part on the selected one or more alternate output tokens.

In some embodiments, the ML model comprises a transformer neural network. The different logits of the plurality of logits may be generated at different stages of the transformer neural network.

In some embodiments, the subset of logits of the plurality of logits is identified based on transforming the plurality of logits into a probability distribution and selecting a number of logits with the highest probabilities in the probability distribution.

In some embodiments, the subset of logits of the plurality of logits is identified based on one of greedy sampling, top-k sampling, or top-p sampling of the plurality of logits.

In some embodiments, a respective alternate output of a plurality of alternate outputs is generated based at least in part on a corresponding alternate token of the plurality of alternate tokens and the session context data. The MIMA may receive a preview of each alternate output of the plurality of alternate outputs. Generating the second input may further be based on selecting an alternate token corresponding to a particular preview. The second plurality of output tokens may be generated further based on the alternate output corresponding to the selected alternate token.

In some embodiments, generating the second input may be further based at least in part on providing, to the ML model, a token not included in the plurality of alternate tokens.

In some embodiments, the MIMA provides, to the LLM, a request to remove the first token from the session context data.

In some embodiments, the session context data is stored in a graphics processing unit (GPU) associated with the ML model. The session context data may be moved from the GPU to a central processing unit (CPU) associated with the ML model at a time after the first input is provided to the ML model and before the second input is provided to the ML model. The session context data may be moved from the CPU to the GPU when the second input is provided to the ML model.

In some embodiments, generating the second input is further based at least in part on determining that an error in an at least one of agentic workflow or programmatic application programming interface (API) is associated with the first one or more tokens.

In some embodiments, the MIMA generates, for presentation on a user device, an output based at least in part on the first plurality of output tokens, the second plurality of output tokens, and/or the supplemental context data.

A benefit of the described systems and methods includes reducing unnecessary or excess consumption of computing and processing resources when fine-tuning an ML model, for instance, by preserving and maintaining the session context data when intercepting the ML model to correct the ML output.

Another benefit includes improving the ability of the ML model to accurately and appropriately handle tasks involving subjective judgment or ambiguity, for instance, by intercepting the ML model to make granular edits to the ML output while preserving the context window.

Yet another benefit includes reducing excess use of memory to store and preserve hidden vectors in hidden layers of the ML model, such as with an LLM, during interception. Allowing for in-segment modification of LLM inferencing and maintaining the session context data during the modification can remove or reduce the need to modify the hidden state vectors for each word to be modified and tracking those hidden state vectors as they get passed between the layers of the LLM.

Yet another benefit includes reducing latency that may arise when there are multiple interactions between an ML model and one or more users or AI agents, for instance, by storing the context data in GPU and temporarily swapping the context data to the CPU to allow the GPU to perform other operations while still maintaining the context window.

Although some of the examples in the disclosure describe using the systems and methods in the context of LLMs, it is understood that the systems and methods described herein can be applied in any other suitable context, including any other suitable ML model or models.

### BRIEF DESCRIPTION OF THE FIGURES

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 shows an example scenario of intercepting and modifying ML model inferencing, in accordance with an embodiment of the disclosure;

FIG. 2 shows an example graphical user interface (GUI) for intercepting and modifying ML model inferencing, in accordance with an embodiment of the disclosure;

FIG. 3 shows an illustrative user equipment device, in accordance with an embodiment of the disclosure;

FIG. 4 shows an illustrative system, in accordance with an embodiment of the disclosure;

FIG. 5 is a flowchart of an example process for modifying ML model inferencing, in accordance with an embodiment of the disclosure;

FIG. 6 is a system sequence diagram of an example process of modifying ML model inferencing using an agentic workflow, in accordance with an embodiment of the disclosure;

FIG. 7 is a system sequence diagram of an example process of iterative ML model inferencing of previously inferenced output, in accordance with an embodiment of the disclosure;

FIGS. 8A and 8B are system sequence diagrams of an example process for modifying ML model inferencing based on pattern recognition, in accordance with an embodiment of the disclosure;

FIG. 9 is a system sequence diagram of an example process for modifying ML model inferencing based on various parameters or attributes, in accordance with an embodiment of the disclosure;

FIG. 10 is a system sequence diagram of another example process for modifying ML model inferencing based on various parameters or attributes, in accordance with an embodiment of the disclosure;

FIG. 11 is a system sequence diagram of yet another example process for modifying ML model inferencing based on various parameters or attributes, in accordance with an embodiment of the disclosure;

FIG. 12 is a system sequence diagram of an example process for providing previews of alternate ML model inferencing outputs, in accordance with an embodiment of the disclosure; and

FIG. 13 is a flowchart of another example process for modifying ML model inferencing, in accordance with an embodiment of the disclosure.

### DETAILED DESCRIPTION

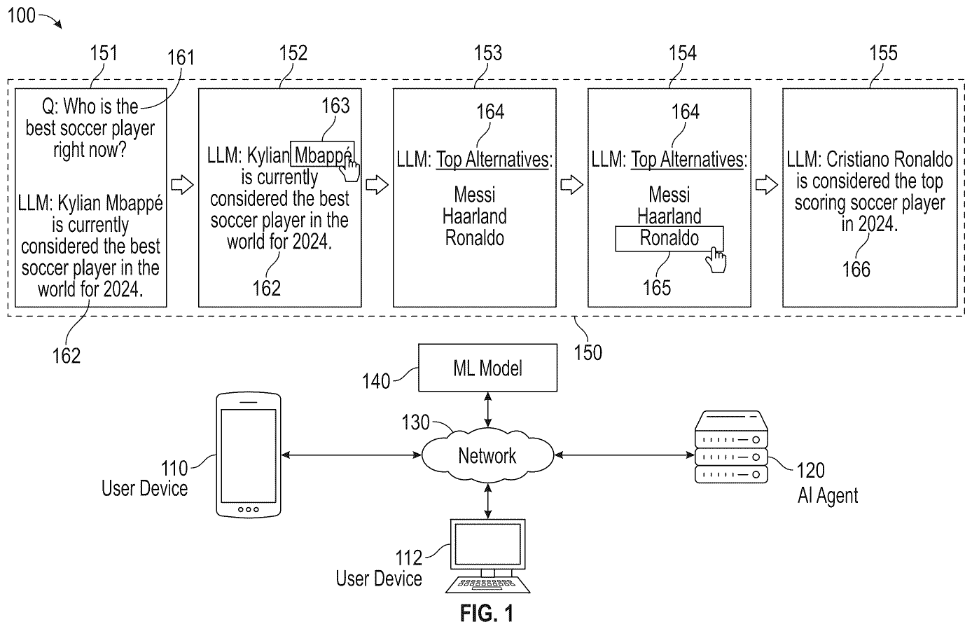

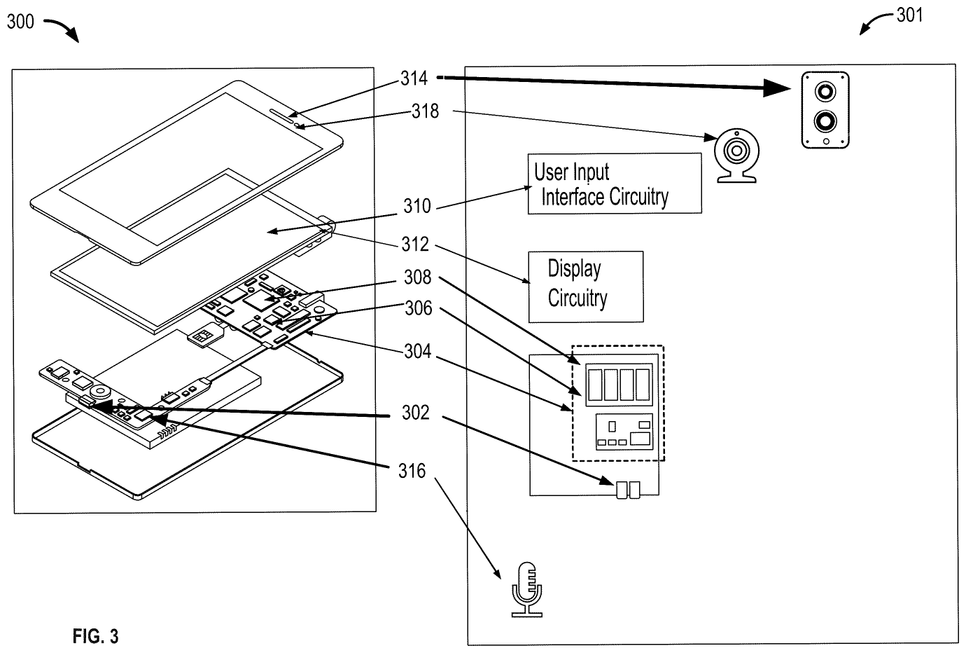

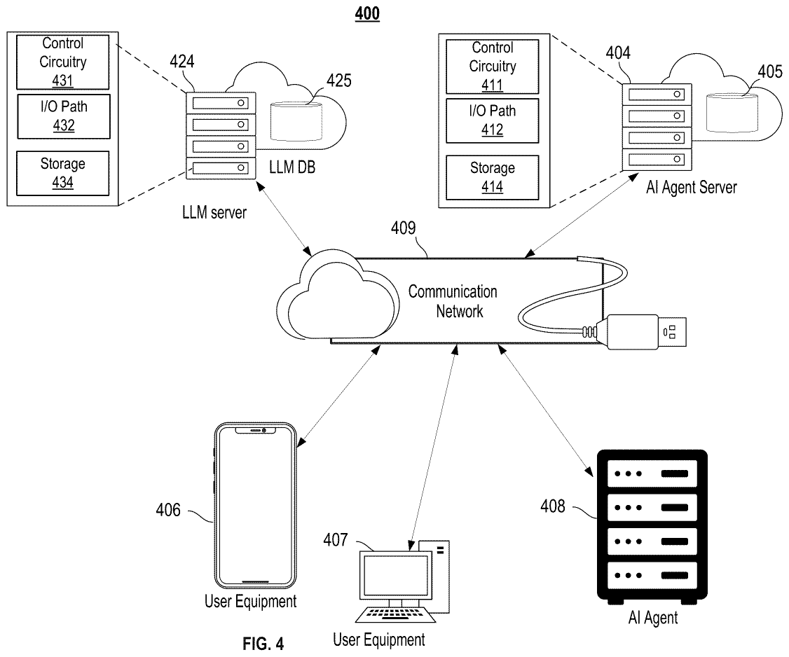

FIG. 1 shows an example scenario 100 of intercepting and modifying ML model inferencing, in accordance with an embodiment of the disclosure. In the example, scenario 100 may include user devices 110, 112, AI agent 120, one or more ML models 140, and network 130. In some embodiments, the MIMA is configured to perform functionalities (or any suitable portion of the functionalities) described herein. For example, the MIMA may provide an interface (e.g., programmatic API) through which AI agent 120 and user devices 110, 112 may interact with the ML model 140 (e.g., directly or by way of AI agent 120). The MIMA may be embedded in an application associated with user devices 110, 112, or AI agent 120 (e.g., by way of one or more APIs), may be a stand-alone application, or may be incorporated in any other suitable platform or application. In some examples, AI agent 120 may comprise the MIMA (e.g., as part of an AI agentic system of AI agent 120). In some examples, the MIMA may comprise AI agent 120 and/or ML model 140. In some examples, the MIMA may be at least partially implemented as part of, or executed at least in part utilizing, user device 110, 112, AI agent 120, user devices 300 or 301 of FIG. 3, user devices 406, 407 of FIG. 4, AI agent 408 of FIG. 4, databases 405 or 425 of FIG. 4, and/or servers 404 or 424 of FIG. 4, or one or more remote servers, and/or at or distributed across any of one or more other suitable computing devices, in communication over any suitable type of network (e.g., the Internet, network 130).

In some embodiments, user devices 110, 112 comprise any one of smartphones, tablets, personal computers, desktop computers, laptops or notebooks, smartwatches or other wearable devices, virtual reality or augmented reality devices, any other suitable computing device, or any combination thereof.

In some embodiments, AI agent 120 comprises any suitable device or model configurable to perform agentic workflow. For example, AI agent 120 may be a chatbot (e.g., customer service or support chatbot, or other suitable chatbot), virtual assistant, smart home device, or any other suitable device or model. In some instances, AI agent 120 may be communicatively connected with user device 110, 112. In some embodiments, AI agent 120 is configurable to invoke multiple sessions with ML model 140 simultaneously (e.g., in parallel). For instance, AI agent 120 may perform, simultaneously, multiple agentic workflow steps or processes that query ML model 140 and integrate responses from ML model 140. In some embodiments, the system 100 may comprise multiple AI agents 120 that each interface with ML model 140 (e.g., invoke or query ML model 140, intercept ML model 140, integrate ML model 140 responses) simultaneously when performing their respective agentic workflow or workflows. In some embodiments, an AI agent may invoke ML model 140, intercept data from ML model 140, or integrate ML model 140 responses into its workflow indirectly by way of interfacing with another AI agent that directly interfaces with ML model 140. In some examples, an AI agent system of AI agent 120 comprises ML model 140 (e.g., AI agent 120 and ML model 140 may be part of the same AI agentic system of AI agent 120).

In some embodiments, ML model 140 comprises an LLM or other suitable ML model. For example, ML model 140 may comprise a transformer neural network, a recurrent neural network, or any other suitable natural language processing (NLP) model.

In some embodiments, network 130 comprises any suitable type of network. Any one or more of user device 110, 112, AI agent 120, or ML model 140 may communicate with each other or with any one or more other suitable computing devices or models over network 130.

According to some embodiments, at step 151 of FIG. 1, a session 150 (e.g., an inferencing session) with ML model 140 is initiated when a prompt (e.g., input 161) is provided (e.g., by user device, 110, 112, and/or AI agent 120) to ML model 140. In some embodiments, input may be provided to ML model 140 in a sequential manner (e.g., by one input prompt from one input source at a time), or in parallel (different input prompts from one or more AI agents). In some embodiments, input may be provided to the ML model 140 granularly (e.g., one word or phrase at a time, by a given input source). Additionally, or alternatively, ML model 140 may simultaneously perform multiple inferencing sessions with multiple devices, AI agents, or both. For instance, user device 110, 120, AI agent 120, one or more additional AI agents, or a combination thereof, may simultaneously provide input to, receive and integrate output from, or intercept the output of ML model 140.

Illustratively, an AI agent may receive an original input prompt or query via a user device, and break-down or separate the input prompt into multiple different prompts that together are intended to provide an appropriate response to the original prompt. For instance, a query such as “Help me do my taxes,” may result in an AI agent providing inputs to one or more ML models that are configured or responsive to different aspects of the query, e.g., ML model(s) for or that interface with financial institutions may provide tax forms and transaction data, an ML model for or that interfaces with a state government website may provide information on local taxes and deductions, an ML model for or that interfaces with a tax preparation provider may be provided (in parallel or in sequence) a number of input prompts to provide instructions to fill-out and/or submit forms, etc.

In another example, user device 110 may query the ML model 140 with input 161 (“Who is the best soccer player right now?”). Based on input 161, ML model 140 may determine context data for the session (e.g., soccer players, performance statistics and skills of the soccer players, soccer tournament scores). The context data may include word vectors from hidden and output layers of the ML model (such as with an LLM), which the MIMA may store in memory (e.g., storage 308 of FIG. 3). Based on input 161 and the context data, ML model 140 may generate logits for determining tokens corresponding to possible responses to input 161. Logits are raw, unnormalized scores for each possible token in the vocabulary of ML model 140. Logits may indicate the likelihood of each token to be the next predicted word in a sequence (e.g., of a response output) based on the input context (e.g., input 161, session context data, or both). In some instances, the logits may be transformed into a probability distribution (e.g., using a SoftMax function or other suitable function) that reflects the likelihood of each token being selected as the next word. The ML model may determine the tokens with the highest likelihood of being selected based on input 161, the context data of the session, or both. Based on determining these tokens, the ML model 140 may generate a first response. For example, ML model 140 may respond to input 161 with output 162 (“Kylian Mbappé is currently considered the best soccer player in the world for 2024.”).

According to some embodiments, at step 152 of FIG. 1, the MIMA may intercept data from ML model 140 (e.g., by way of user device 110, 112 or AI agent 120). For instance, the MIMA may identify at least a part of output 162 to be modified in-segment (e.g., by selecting one or more tokens of output 162). In the example, the MIMA indicates that token 163 (“Mbappé”) is to be modified. In some instances, the MIMA intercepts ML model 140 at different phases of ML model output (e.g., intercepting an intermediate task such as an arithmetic step, image generation, or text-to-speech (TTS)). In some embodiments, the interception causes or the AI agent otherwise instructs the ML model 140 to temporarily pause its inferencing process (e.g., hence dividing the inferencing process into multiple inferencing portions or segments before and after a timepoint corresponding to the pause), instead of terminating the inferencing and discarding context data of the session 150 and initiating a new ML model session. For example, a first inferencing portion of inferencing session (e.g., ML model session 150) may comprise step 151 (e.g., inferencing output 162 based on input 161), followed by interception of the inferencing at step 152 (e.g., indication to make a partial modification of output 162, e.g., by way of selecting token 163), and followed by a second inferencing portion at steps 153-155 (e.g., inferencing output 166 based on modifying the original output 162 with the selection of an alternate token 165) of the same inferencing session (e.g., session 150).

In some embodiments, the MIMA determines when to intercept ML model 140 (e.g., by way of modifying token 163) based on identifying an error in output 162 or an error (or a likelihood of an error) resulting from application of output 162 to one or more processes. For example, the MIMA may determine that output 162 is a hallucination, has a certain likelihood of resulting in a hallucination (e.g., in subsequent ML model outputs), disrupts or is likely to disrupt agentic workflow, based on supplemental context data, any other suitable factor, or a combination thereof. For instance, the MIMA may determine that token 163 is inconsistent with supplemental context data (discussed in further detail below) or that more detail is needed or desired with respect to token 163 based on the supplemental context data. In another instance, output 162 or token 163 may be data that is out of bounds with respect to the parameters of the agentic workflow of AI agent 120 or that may cause agentic workflow failure (e.g., structured query language (SQL) query failure, code executor or compiler failure, resulting in a mathematical equation that is undefined such as a division by zero, violation of a rule or conditions, or any other suitable processing or programming failure).

In some embodiments, when intercepting ML model 140, the MIMA instructs ML model 140 to save the tokens (e.g., context window tokens or context tokens) associated with the current session. The MIMA may modify a portion within a segment (e.g., output 162) of the intercepted ML model 140 (e.g., at steps 152-154 of FIG. 1, described below). The MIMA may then instruct ML model 140 to resume inferencing based on the modified segment and the preserved tokens from the session.

Additionally, or alternatively, in some embodiments, the MIMA may determine when to intercept ML model 140 (e.g., by way of modifying token 163) based on supplemental context data or other suitable data. Supplemental context data may include: one or more parameters associated with context data of the session; modification of the one or more parameters; inputs to or outputs from ML model 140; one or more attributes associated with inputs to or outputs from ML model 140; modification of the one or more attributes; data associated with one or more users or user profiles; data associated with agentic workflow settings, rules, processes, conditions, and the like; user or other input to or output from agentic workflow; context data associated with one or more previous or other sessions between ML model 140, user device 110, 120, and/or AI agent 120; context data associated with one or more sessions between AI agent 120 and a user; any other suitable data; or a combination thereof.

For instance, parameters for the context data of session 150, input 161, or output 162 may include how the best soccer player may be defined (e.g., identifying the current best soccer player based on performance, statistics, skill set, top scores, number of games won, league), the time frame (e.g., best soccer player currently or of all time), location (e.g., best soccer in Europe or internationally), or any other suitable parameter. Attributes of inputs or outputs from the ML model 140 and/or the AI agent 120 may include certain terms or phrases, tone, length, language style, audience, level of detail, or other suitable properties or characteristics of input 161, output 162, or both. User profile data may include profile or preferences data of one or more users associated with user device 110, 112, AI agent 120, ML model 140, or a combination thereof. Agentic workflow settings data may relate to the settings, workflow, functions, tools, rules of the AI agent service provider or user, or other suitable configurations, capabilities, or components of AI agent 120.

Supplemental context data may also include context data associated with the agentic workflow of AI agent 120. For example, in addition to monitoring and maintaining the context data of the ML model session 150, the MIMA may monitor and maintain context data associated with context data of the AI agent session or sessions with a user by way of user device 110, 112. The supplemental context data may include private, sensitive, proprietary, or other information that is managed by the MIMA or AI agent, and otherwise not available to the ML model. For instance, AI agent 120 may be a virtual tax assistant that is interfacing with ML model 140 to prepare tax forms for the current year for a user. Separately from the context of ML model session 150, AI agent 120 may have prepared tax forms for the user for previous tax years, and has access to user data that is not shared with the ML model. AI agent 120 may monitor and maintain this context data of its own sessions with the user (e.g., for data privacy). AI agent 120 may use this supplemental context data to determine when to intercept the ML model 140 and modify tax-related responses from ML model 140, such as modifying the output to accommodate which state the user is currently filing in, whether the user has previously filed tax returns in other states, or whether the user has changed their filing status (e.g., single or married).

In another instance, AI agent 120 may be a customer service AI agent that is interfacing with ML model 140 to identify a retail item for purchase for a user. AI agent 120 may store or otherwise have access to user profile data of the user, such as the user's location or shopping history. AI agent 120 may use this supplemental data to determine when and/or how to intercept ML model 140 and modify the recommended item. For instance, AI agent 120 may determine that the recommended item can only be shipped to Europe, but the user resides in the United States. AI agent 120 may instruct ML model 140 to pause inferencing and save the context of the session (e.g., preserve context tokens associated with the shopping session or with the type of item the user is searching to). During interception, AI agent 120 may modify various parameters of the ML model 140 output (e.g., available shipping locations of the recommended item). AI agent 120 may then instruct the ML model 140 to resume inferencing based on the updated parameters and the saved context.

In yet another instance, the customer service AI agent may receive an output from ML model 140 that conflicts with the business offerings or other business policies of the retail provider of AI agent 120. For example, AI agent 120 may prompt ML model 140 for suggestions on handling an item purchased by a user that was delivered to the wrong address. ML model 140 may provide a recommendation to request a refund within three weeks of purchase, but AI agent 120 may determine that the recommendation conflicts with the retailer's business policy, which requires that refunds be requested within two weeks of purchase. Thus, AI agent 120 may intercept and modify the ML model 140 output based on this supplemental context data.

According to some embodiments, at step 153 of FIG. 1, based on providing the indication to modify token 163 of output 162, the MIMA may cause ML model 140 to provide one or more alternative tokens with which to modify the ML model response in-segment. For instance, ML model 140 may provide a list of the top alternate tokens 164 that were considered but not selected for output (e.g., output 162) when generating a response based on input 161 and session 150 context data. In the example, in generating a response to input 161 (“Who is best soccer player right now?”), ML model 140 had considered the athletes Mbappé, Messi, Haarland, and Ronaldo, but ultimately selected Mbappé as the most likely correct or appropriate answer to the query. However, a user (or AI agent) may disagree with the output 162 and may wish to modify a portion of output 162 (e.g., token 163). For instance, ML model 140 may have generated logits corresponding to various tokens in the ML model 140 vocabulary, transformed the logits into a probability distribution, identified the corresponding tokens with the highest probabilities (e.g., Mbappé, Messi, Haaland, and Ronaldo), ranked the tokens based on the probabilities, and selected the top-ranked token (e.g., Mbappé) for output 162. Upon receiving the selection of token 163 for modification, ML model 140 may provide the alternate athletes with the next highest token rank (e.g., Messi, Haaland, and Ronaldo).

In some embodiments, the ML model 140 determines the alternate tokens based on the aforementioned transformation of logits into a probability distribution. For instance, the ML model 140 may use a SoftMax function, or any other suitable function, to transform the logits into the probability distribution. The distribution may reflect the likelihood of each corresponding token being predicted as the next word in a sequence (e.g., output 162) based on input 161, session 150 context data, or both.

In some embodiments, ML model 140 determines the top alternate tokens 164 based on various sampling models. ML model 140 may also determine the number of top alternate tokens (e.g., from a plurality of potential alternate tokens) for presentation based on the various sampling models. In some instances, ML model 140 may determine the top alternate tokens 164 based on a greedy sampling model. ML model 140 may select the token with the highest probability directly. In some instances, ML model 140 may determine the top alternate tokens 164 based on top-k sampling. ML model 140 may consider the top k tokens with the highest probabilities and samples from this subset. Top-k sampling may help to result in more diversity in the output. In some instances, ML model 140 may determine the top alternate tokens 164 based on top-p (nucleus) sampling. Rather than determining a fixed number of tokens, ML model 140 may consider tokens until their cumulative probability exceeds a particular threshold (p).

In some embodiments, the MIMA accesses the top alternate tokens 164 of ML model 140 via various techniques. For example, the MIMA may modify the token generation parameters of ML model 140. The MIMA may adjust parameters (e.g., top-k or top-p parameters) when invoking the token generation model associated with ML model 140. Based on adjusting the parameters, the MIMA may be able to retrieve a set of possible candidate tokens from which the final (e.g., optimal) token (e.g., token 163) was chosen for output 162. In another example, the MIMA may access (e.g., request and receive, or obtain permission or authorization to access) the logits directly from ML model 140 before they are transformed into probabilities. The MIMA may analyze the logits and identify the tokens corresponding to those logits with particular scores (e.g., significantly higher scores relative to those of other logits, scores above a particular threshold).

In yet another example, the MIMA may access the top alternate tokens 164 by retrieving and ranking the top k candidate tokens that could potentially follow another token in the ML model response. For each corresponding word or phrase that is generated for each candidate token (regardless of whether they are selected for output), the MIMA may store the corresponding tokens as metadata that can later be accessed by user device 110, 112 or AI agent 120 (e.g., directly or via an API). An example pseudocode for this example is shown below. It will be understood that the example pseudocode is merely illustrative of one particular way of identifying and accessing alternate tokens. Any other suitable deterministic technique may be used and in any suitable context.

python
from transformers import AutoModelForCausalLM, AutoTokenizer
import torch
# Load model and tokenizer
model_name = “gpt2”
tokenizer = AutoTokenizer.from_pretrained(model_name)
model = AutoModelForCausalLM.from_pretrained(model_name)
# Input text
input_text = “The weather today is”
input_ids = tokenizer.encode(input_text, return_tensors=‘pt’)
# Get logits for the next token
with torch.no_grad( ):
outputs = model(input_ids)
logits = outputs.logits[:, −1, :] # Get logits for the last token
# Convert logits to probabilities
probabilities = torch.softmax(logits, dim=−1)
# Get top-k candidates
top_k = 5
top_k_values, top_k_indices = torch.topk(probabilities, top_k)
# Decode top-k tokens
top_k_tokens = tokenizer.decode(top_k_indices[0])
print(“Top-k candidates:”, top_k_tokens)

In some embodiments, ML model 140 generates the logits at different layers (also referred to as stages) of its neural network (e.g., different stages or layers in the transformer neural network, inferencing session segments, or other suitable neural network or multilayer ML model). In some instances, a segment may span one or more particular neural network layers. In some instances, a segment may include a latency window (e.g., 10 ms, 5 ms) during which AI agent 120 requests a response from ML model 140. The MIMA may identify and access these logits to determine the top alternate tokens 164 by implementing one or more statistical models (such as correlation coefficients) to analyze how logit values change across layers for given inputs. Based on the statistical models, the MIMA may determine which layers are associated with output that is most closely associated with a target logit value (e.g., a specific value, a value above a particular threshold, a value within a certain range of or closely related to a particular value such as the logit of the output token 163). The MIMA may collect the appropriate logits from these determined layers. The MIMA may apply dimensionality reduction techniques (such as principal component analysis (PCA)) on the collected logits from the various layers to visualize and identify patterns that correlate with specific logit values. The MIMA may implement any suitable classification or clustering ML model to classify or cluster logit outputs based on their properties. For instance, the MIMA may train a classifier based on labeled data indicating which layer corresponds to various logit values.

According to some embodiments, at step 154 of FIG. 1, the MIMA provides a second input 165 (e.g., by way of user device 110, 112 or AI agent 120) based on the selected token 163, supplemental context data, the list of top alternate tokens 164, or a combination thereof. In the example, the MIMA may select, based on supplemental context data (e.g., user preferences, parameters for defining the best soccer player) alternate token 165, which may be provided to ML model 140 as the second input. In another example, the MIMA may provide, based on supplemental context data, a different (e.g., new) alternate token that is not listed in the top alternate tokens 164 (e.g., Pele). In some embodiments, the second input comprises an in-segment modification of the ML model 140 inferencing and therefore removes the need to provide the clarification or modification of output 162 via an entirely new prompt to ML model 140, which may otherwise cause the ML model 140 to discard the current session 150 context data and initiate a new ML model session. Thus, the MIMA may store and maintain the context data in memory (e.g., storage 308 of FIG. 3, shared high bandwidth memory coupled with a computing unit, or other suitable storage) while awaiting an edited or modified input (e.g., second input 165) and throughout session 150, despite the interception of ML model 140 inferencing (e.g., at steps 152, 154 of FIG. 1). Preserving the context data of the session 150 and providing for the in-segment modification of output 162 may also help to avoid the need to modify hidden state vectors (e.g., in hidden layers of ML model 140) for token 163, output 162, or both and tracking those hidden state vectors as they get passed between the layers of ML model 140. As such, this reduces or removes the need to preserve hidden vectors from the otherwise discarded previous inferencing operation, thereby saving memory storage space.

In some embodiments, the MIMA receives (e.g., by way of AI agent 120) the output 162 as an output vector. The MIMA may intercept ML model 140 and provide the second input for modifying the ML model inferencing by changing one or more portions of the output vector. The change request may be performed programmatically via an API call. Example pseudocode for modifying the output vector is shown below. It will be understood that the example pseudocode is merely illustrative of one particular way for modifying the ML model output. Any other suitable modification technique or mechanism may be implemented and in any suitable context.

$$LLM2AIAgent\_ReceivedOutputVector = \{ w 1 , w 2 … wn \}$$

$$AIAgent2\_LLM \_Modified \_Vector = \{ w 2 , wx \}$$

In the example pseudocode, the MIMA may receive an output vector comprising tokens {w1, w2, . . . , wn}. The MIMA may change the output vector such that it is modified to comprise tokens {w2, wx}. The MIMA may transmit the request or instruction for the modified vector to ML model 140. The instruction may cause ML model 140 to edit its own previous output (e.g., output 162) and replace the (w2) token with the alternate token (wx) (e.g., replace token 163 with alternate token 165). The MIMA may instruct ML model 140 to integrate the alternate token 165 in performing the remainder of the inferencing steps.

In some embodiments, AI agent 120 requests feedback from the user as to selecting from the list of top alternate tokens 164 (e.g., selection of the second input 165), which the AI agent 120 provides to ML model 140. In some embodiments, AI agent 120 automatically or programmatically analyzes and selects second input 165 from the list of top alternate tokens 164 based on supplemental context data, for example.

Additionally, or alternatively, during interception, the user or AI agent 120 may request the ML model 140 to provide its reasoning (e.g., rules, steps such as intermediary steps, conditions, or other suitable processes the ML model 140 applied during inferencing) for selecting “Mbappé” as output 162. AI agent 120 may instruct ML model 140 to maintain the data associated with its reasoning, such as intermediary steps, as stateful, such that the session context data is preserved (e.g., remains stateful) during the interception. User or AI agent may wish to modify the reasoning of the ML model 140 without having to provide a new prompt. For instance, user or AI agent 120 may modify the parameters of the context window or attributes of output 162 (e.g., best soccer player based on skillset or number of tournaments won, best soccer player currently or of all time, best soccer player in women's soccer, redefine “soccer” to include indoor soccer and beach soccer) and instruct ML model 140 to resume inferencing the best soccer player based on the modified parameter.

According to some embodiments, at step 155 of FIG. 1, the MIMA may instruct ML model 140 to update its previous output 162 with modified output 166 based on the interception (e.g., steps 152, 154 of FIG. 1) and to resume inferencing within the same session 150 context. Hence, the interception may augment ML model 140.

Additionally, or alternatively, in some embodiments, if the MIMA does not receive a selection of alternate token 165 a new token entry to modify selected token 163, or other suitable modification of output 162, within a certain period of time, then the MIMA automatically causes ML model 140 to resume its inferencing without further input from user device 110, 112, or AI agent 120. In another embodiment, if the modification of token 163 is not received within a certain period of time, the MIMA considers inferencing to be complete (e.g., considers that output 162 is final), and may discard saved context data of session 150, and terminate the session 150.

In some embodiments, the MIMA stores the context data of session 150 in the GPU. For instance, the MIMA may store a context ID of the session context data, and the corresponding context data may be stored in memory. When ML model 140 is intercepted and is awaiting the second input 165, the MIMA may perform a swap operation to move intercepted context data of session 150 from the GPU to the CPU (e.g., by way of a GPU/CPU link). When ML model 140 receives the second input 165 and resumes inferencing, the MIMA may move the context data back from CPU to GPU, so that ML model 140 may retrieve the context data to infer the next output (e.g., output 166) based on the second input 165. Therefore, during interception or pause of ML model 140, GPU resources (e.g., memory allocation and GPU computation) continue to be available for additional, simultaneous queries from or other interactions between user devices 110, 112, AI agent 120 (or multiple user devices and/or AI agents) with ML model 140. This may reduce latency that might otherwise result from running these ML model 140 interactions in parallel. In some embodiments, the MIMA may instruct ML model 140 to perform the swap operation. In some embodiments, the swap operation may be at least partially executed by AI agent 120.

Additionally, the MIMA may instruct ML model 140 to refine the swap operation into chunked mode, such that the swap operation may run in a pipeline fashion, further reducing latency. For example, the MIMA may determine to perform the swap operation in chunked mode (e.g., swapping the context data piece by piece as opposed to all at once) based on identifying whether other tasks need to run on the GPU during interception (e.g., based on the current tasks or queued tasks of the GPU), determining the size of the context data that will be swapped, or both. If the task is latency sensitive, the swap operation may be performed all at once (e.g., not in chunked fashion). If the task is not latency sensitive, then the swap operation may be performed in chunked fashion.

The GPU/CPU swap operation may also help save computation resources while making memory and storage resources available for other operations. When the MIMA intercepts ML model 140, ML inferencing stops (e.g., pauses) and the context data is no longer needed during that time. The GPU/CPU swap operation preserves the context data even when the intercepted ML model 140 is not retrieving or utilizing the data, while removing the need to use resources (e.g., GPU resources) to recompute all of the context data at a time when ML model 140 does resume inferencing (and needs to retrieve the context data to support the inferencing). Further, the GPU/CPU swap operation may help reduce unnecessary or excess use of storage, since pausing ML inferencing as ML model 140 awaits the modified input would require a large amount of GPU memory (e.g., for preservation of the session 150 context data) that is otherwise not being used (e.g., not actively or currently retrieving session 150 context data) during the interception.

In some embodiments, the MIMA causes ML model 140 to run the inferencing from the replacement word layer (e.g., of an LLM neural network associated with the ML model 140). In other embodiments, the MIMA causes ML model 140 to run the inferencing starting from the initial layer of ML model 140. When the MIMA determines a match between a logit and its corresponding replacement word or words, the MIMA may switch storage of the context data between the CPU and GPU and update the context data to resume the inferencing. This can avoid preserving the hidden vectors from the previous inferencing operation and save memory space. In some examples, if ML model 140 has prior knowledge of inferencing not changing any feed-forward paths of the GPU processing, ML model 140 may optimize resources by stopping the inferencing and simply present the rest of the output.

In some embodiments, the MIMA updates the session 150 context window by removing token 163 from the context data. For instance, the MIMA may receive a request from user device 110, 112 or AI agent 120 to delete or otherwise omit token 163 such that it would not be considered in future inferencing (e.g., as token 153 may be incorrect or irrelevant). In another instance, the MIMA may determine that token 153 is a hallucination or would result in a hallucination, and that preserving it in the session 150 context data would otherwise result in further hallucinations or other inferencing errors, end-user application failures, or agentic workflow errors. Based on this determination, the MIMA may delete or otherwise exclude token 153 from the session 150 context data.

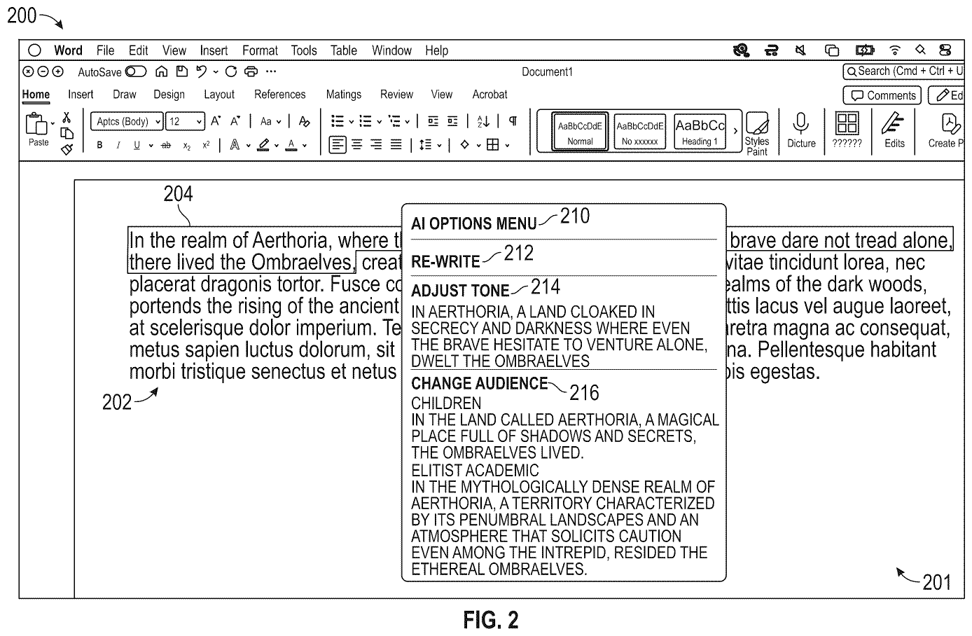

FIG. 2 shows an example graphical user interface (GUI) 200 for intercepting and modifying ML model inferencing, in accordance with an embodiment of the disclosure. In the example, ML model 140 may have generated text 202 (e.g., displayed within a structured document interface, such as a word-processing document 201, an HTML page, a PDF file, chat or messaging interface, or any other suitable interface). The MIMA (e.g., by way of user device 110, 112, or AI agent 120) may select portion 204 of text 202. The selection of portion 204 may comprise an interception request that causes ML model 140 to intercept its inferencing. In particular, the interception request may comprise a request to iterate the inferencing (e.g., re-inferencing) of text 202, portion 204, or other portions surrounding portion 204. For instance, re-inferencing text may include re-processing by ML model 140 of selected text within the surrounding document context (e.g., context data of the ML model session). Upon re-inferencing the text, ML model 140 may modify only the selected portion 204, portions surrounding portion 204, or the entirety of text 202.

In some embodiments, by way of the interception request (e.g., re-inferencing request), the MIMA may cause ML model 140 to provide a list of parameters, attributes, or other suitable options for modifying the output (e.g., text 202) or the selected token or tokens therein (e.g., portion 204). The list may be a menu of options 210, wherein each option may correspond with a set of alternate tokens representing a modified output of portion 204 or text 202 based on the re-inferencing the text under the option. For instance, options may include rewriting 212 portion 204 (e.g., rearranging the text of portion 204 or rewriting portion 204 to incorporate supplemental text provided by the MIMA), adjusting the tone 214 of portion 204, or changing the audience 216 and modifying portion 204 to be appropriate for the changed audience. Based on the selected option, the MIMA may cause ML model 140 to modify portion 204 and present the modified version of portion 204 in place of the original version of portion 204. In some examples, the MIMA may also cause ML model 140 to modify the portions surrounding portion 204 or the entire text 202 and replace presentation of the original text with the modified text. In some embodiments, the MIMA may cause ML model 140 to display respective previews corresponding to each option, from which the MIMA may then select for replacing the original selected text.

FIGS. 3-4 depict illustrative devices, systems, servers, and related hardware for modifying ML model inferencing, in accordance with some embodiments of this disclosure. FIG. 3 shows generalized embodiments of illustrative user equipment devices 300 and 301, which may correspond to any of the above-described user devices (e.g., user device 120, 220). In some embodiments, user equipment device 300, 301 is a smartphone device, a tablet, an XR device such as a head-mounted display (HMD), or any other suitable device capable of displaying XR content, smart TV, IoT device, smart assistant device or home assistant device, a camera device or any other suitable computing device, a network-based server hosting a user-accessible client device, a non-user-owned device, any other suitable device, or any combination thereof. Each of user equipment device 300, 301 is communicatively connected to at least one of microphone 316, audio input equipment, camera 318, display circuitry 312, and user input interface circuitry 310. For example, display 312 may be a computer display, a 3D display (such as, for example, a tensor display, a light field display, a volumetric display, a multi-layer display, an LCD display or any other suitable type of display, or any combination thereof). For example, user input interface 310 may be a remote-control device.

In some embodiments, each one of user equipment device 300, 301 receives content and data via input/output (I/O) path (e.g., circuitry) 302. I/O path 302 provides data to control circuitry 304, which comprises processing circuitry 306 and storage 308. Control circuitry 304 is used to send and receive commands, requests, and other suitable data using I/O path 302, which comprises I/O circuitry. I/O path 302 connects control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable control circuitry such as processing circuitry 306. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for the MIMA or other suitable application stored in memory (e.g., storage 308). Specifically, control circuitry 304 may be instructed by the MIMA to perform the functions discussed above and below. In some implementations, processing or actions performed by control circuitry 304 may be based on instructions received from the MIMA or other suitable application or platform.

In some client/server-based embodiments, control circuitry 304 may include communications circuitry suitable for communicating with a server or other networks or servers. The MIMA is a stand-alone application implemented on a device or a server. The MIMA may be implemented as software or a set of executable instructions. The instructions for performing any of the embodiments discussed herein of the MIMA may be encoded on non-transitory computer-readable media (e.g., a hard drive, random-access memory on a DRAM integrated circuit, read-only memory on a BLU-RAY disk, etc.). For example, in FIG. 3, the instructions may be stored in storage 308, and executed by control circuitry 304 of a device 300, 301.

In some embodiments, the MIMA is a client/server application where only the client application resides on device 300, 301 and a server application resides on an external server (e.g., server 404, 424). For example, the MIMA may be implemented partially as a client application on control circuitry 304 of device 300, 301 and partially on server 404, 424 as a server application running on control circuitry 411, 431, respectively. Server 404, 424 may be a part of a local area network with one or more of devices 300, 301 or may be part of a cloud computing environment accessed via the internet. In a cloud computing environment, various types of computing services for performing searches on the internet or informational databases, providing encoding/decoding capabilities, providing storage (e.g., for a database) or parsing data (e.g., using machine learning algorithms described above and below) are provided by a collection of network-accessible computing and storage resources (e.g., server 404, 424), referred to as “the cloud.” Device 300, 301 may be a cloud client that relies on the cloud computing capabilities from server 404, 424 to receive and process encoded data. When executed by control circuitry of server 404, 424 the MIMA instructs control circuitry 411, 431, respectively, to perform processing tasks for the client device.

Control circuitry 304 may include communications circuitry suitable for communicating with a server, edge computing systems and devices, a table or database server, or other networks or servers. The instructions for carrying out the above-mentioned functionality may be stored on a server (which is described in more detail in connection with FIG. 4). Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communication networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as ML model inferencing modification application data described above. Nonvolatile memory may also be used (e.g., to launch a boot-up routine and other instructions). Cloud-based storage, described in relation to FIG. 3, may be used to supplement storage 308 or instead of storage 308.

Control circuitry 304 may include video generating circuitry and tuning circuitry, such as one or more analog tuners, one or more H.265 decoders or any other suitable digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and down converting content into the preferred output format of user equipment 300, 301. Control circuitry 304 may also include digital-to-analog converter circuitry and analog-to-digital converter circuitry for converting between digital and analog signals. The tuning and encoding circuitry may be used by user equipment device 300, 301 to receive and to display, to play, or to record content. The tuning and encoding circuitry may also be used to receive video encoding/decoding data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment device 300, the tuning and encoding circuitry (including multiple tuners) may be associated with storage 308.

Control circuitry 304 may receive instruction from a user by way of user input interface circuitry 310. User input circuitry 310 may be any suitable user interface circuitry, such as a remote control, mouse, trackball, keypad, keyboard, touch screen, touchpad, stylus input, joystick, voice recognition interface, or other user input interfaces. Display circuitry 312 may be provided as a stand-alone device or integrated with other elements of each one of user equipment device 300, 301. For example, display circuitry 312 may be a touchscreen or touch-sensitive display. In such circumstances, user input interface circuitry 310 may be integrated with or combined with display circuitry 312. In some embodiments, user input interface circuitry 310 includes a remote-control device having one or more microphones, buttons, keypads, any other components configured to receive user input or combinations thereof. For example, user input interface circuitry 310 may include a handheld remote-control device having an alphanumeric keypad and option buttons.

Audio output equipment 314 may be integrated with or combined with display circuitry 312. Display circuitry 312 may be one or more of a monitor, a television, a liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display circuitry 312. Audio output equipment 314 may be provided as integrated with other elements of each one of device 300 and equipment 301 or may be stand-alone units. An audio component of videos and other content displayed on display circuitry 312 may be played through speakers (or headphones) of audio output equipment 314. In some embodiments, audio may be distributed to a receiver (not shown), which processes and outputs the audio via speakers of audio output equipment 314. In some embodiments, for example, control circuitry 304 is configured to provide audio cues to a user, or other audio feedback to a user, using speakers of audio output equipment 314. There may be a separate microphone 316 or audio output equipment 314 may include a microphone configured to receive audio input such as voice commands or speech. For example, a user may speak letters or words that are received by the microphone and converted to text by control circuitry 304. In a further example, a user may voice commands that are received by a microphone and recognized by control circuitry 304. Camera 318 may be any suitable video camera integrated with the equipment or externally connected. Camera 318 may be a digital camera comprising a charge-coupled device (CCD) and/or a complementary metal-oxide semiconductor (CMOS) image sensor. Camera 318 may be an analog camera that converts to digital images via a video card.

The MIMA may be implemented using any suitable architecture. For example, it may be a stand-alone application wholly-implemented on each one of user equipment device 300 and user equipment device 301. In such an approach, instructions of the application may be stored locally (e.g., in storage 308), and data for use by the application is downloaded on a periodic basis (e.g., from an out-of-band feed, from an Internet resource, or using another suitable approach). Control circuitry 304 may retrieve instructions of the application from storage 308 and process the instructions to provide encoding/decoding functionality and perform any of the actions discussed herein. Based on the processed instructions, control circuitry 304 may determine what action to perform when input is received from user input interface circuitry 310. For example, movement of a cursor on a display up/down may be indicated by the processed instructions when user input interface circuitry 310 indicates that an up/down button was selected. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc.

In some embodiments, the MIMA is a client/server-based application. Data for use by a thick or thin client implemented on each one of user equipment device 300 and user equipment device 301 may be retrieved on-demand by issuing requests to a server remote to each one of user equipment device 300 and user equipment device 301. For example, the remote server may store the instructions for the application in a storage device. The remote server may process the stored instructions using circuitry (e.g., control circuitry 304) and generate the displays discussed above and below. The client device may receive the displays generated by the remote server and may display the content of the displays locally on device 300, 301. This way, the processing of the instructions is performed remotely by the server while the resulting displays (e.g., that may include text, a keyboard, or other visuals) are provided locally on device 300, 301. Device 300, 301 may receive inputs from the user via input interface circuitry 310 and transmit those inputs to the remote server for processing and generating the corresponding displays. For example, device 300, 301 may transmit a communication to the remote server indicating that an up/down button was selected via input interface circuitry 310. The remote server may process instructions in accordance with that input and generate a display of the application corresponding to the input (e.g., a display that moves a cursor up/down). The generated display is then transmitted to device 300, 301 for presentation to the user.

In some embodiments, the MIMA may be downloaded and interpreted or otherwise run by an interpreter or virtual machine (run by control circuitry 304). In some embodiments, the MIMA may be encoded in the ETV Binary Interchange Format (EBIF), received by control circuitry 304 as part of a suitable feed, and interpreted by a user agent running on control circuitry 304. For example, the MIMA may be an EBIF application. In some embodiments, the MIMA may be defined by a series of JAVA-based files that are received and run by a local virtual machine or other suitable middleware executed by control circuitry 404. In some of such embodiments (e.g., those employing MPEG-2 or other digital media encoding schemes), the MIMA may be, for example, encoded and transmitted in an MPEG-2 object carousel with the MPEG audio and video packets of a program.

FIG. 4 is a diagram of an illustrative system 400, in accordance with some embodiments of this disclosure. System 400 may comprise user equipment devices 406, 407, and/or any other suitable number and types of user equipment, AI agent 408 and/or any other suitable number and types of devices or servers associated with providing AI agentic service or workflow, networking equipment capable of transmitting data by way of communication network 409. User equipment devices 406, 407 and AI agent 408 may comprise a smartphone device, a tablet, XR device or any other suitable device capable of processing XR content, smart TV, IoT device, smart assistant device or home assistant device, a camera device or any other suitable computing device, a network-based server hosting a user-accessible client device, a non-user-owned device, any other suitable device, or any combination thereof. Communication network 409 may be one or more networks including the Internet, a mobile phone network, mobile voice or data network (e.g., a 5G, 4G, or LTE network), cable network, public switched telephone network, or other types of communication network or combinations of communication networks. Paths (e.g., depicted as arrows connecting the respective devices to the communication network 409) may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 4 to avoid overcomplicating the drawing.

Although communications paths are not drawn between user equipment devices, these devices may communicate directly with each other via communications paths as well as other short-range, point-to-point communications paths, such as USB cables, IEEE 1394 cables, wireless paths (e.g., Bluetooth, infrared, IEEE 702-11x, etc.), or other short-range communication via wired or wireless paths. The user equipment devices may also communicate with each other directly through an indirect path via communication network 409.

System 400 may comprise content data source 405, ML model data source 425, and/or one or more servers 404, 424. In some embodiments, the MIMA may be executed at one or more of control circuitry 411, 431 of servers 404, 424 respectively (and/or control circuitry of user equipment devices 407, 408, 410).

In some embodiments, servers 404, 424 include control circuitry 411, 431 and storage 414, 434 (e.g., RAM, ROM, Hard Disk, Removable Disk, etc.), respectively. Storage 414, 434 may store one or more databases. Server 404, 424 may also include an input/output path 412, 432, respectively. I/O path 412, 432 may provide encoding/decoding data, device information, or other data, over a local area network (LAN) or wide area network (WAN), and/or other content and data to control circuitry 411, 431, which may include processing circuitry, and storage 414, 434, respectively. Control circuitry 411, 431 may be used to send and receive commands, requests, and other suitable data using I/O path 412, 432, respectively, which may comprise I/O circuitry. I/O path 412, 432 may connect control circuitry 411, 431, respectively (and specifically control circuitry) to one or more communications paths.

Control circuitry 411, 431 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 411, 431 may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 411, 431 executes instructions for an emulation system application stored in memory (e.g., the storage 414, 434, respectively). Memory may be an electronic storage device provided as storage 414, 434 that is part of control circuitry 411, 431, respectively.

Content data source 405, ML model data source 425, servers 404, 424, or any combination thereof, may include an encoder. Such encoder may comprise any suitable combination of hardware and/or software configured to process data to reduce storage space required to store the data and/or bandwidth required to transmit the image data, while minimizing the impact of the encoding on the quality of the media content being encoded. In some embodiments, the data to be compressed may comprise a raw, uncompressed 3D media content, or 3D media content in any other suitable format. In some embodiments, each of user equipment devices 406, 407, or AI agent 408 may receive encoded or encoded data locally or over a communication network (e.g., communication network 409 of FIG. 4) and may comprise one or more decoders. Such decoder may comprise any suitable combination of hardware and/or software configured to convert data in a coded form to a form that is usable as video signals and/or audio signals or any other suitable type of data signal, or any combination thereof. User equipment devices 406, 407, or AI agent 408 may be provided with encoded data. In some embodiments, at least a portion of decoding may be performed remote from user equipment devices 406, 407, or AI agent 408.

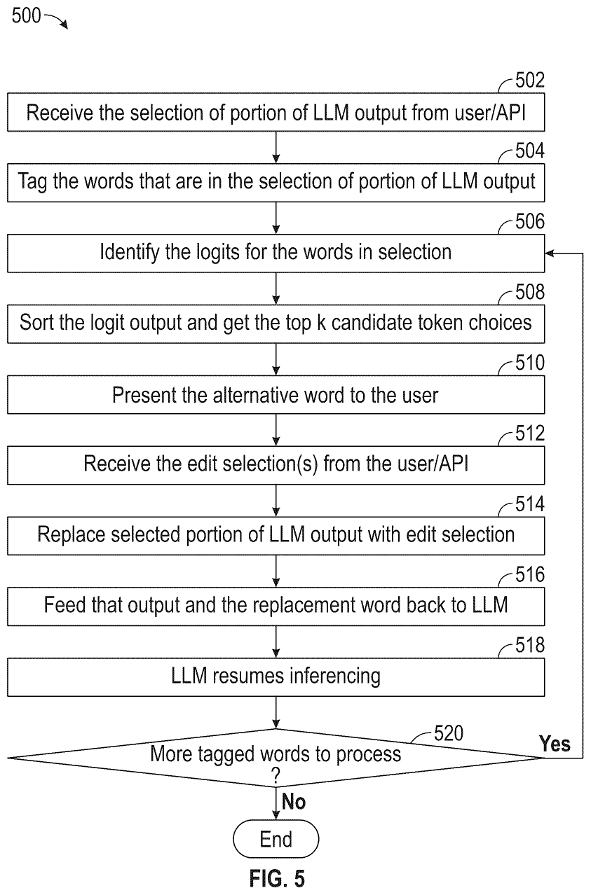

FIGS. 5-13 are system sequence diagrams and flowcharts of various processes 500-1300, respectively. In various embodiments, the individual steps of each process 500-1300 may be implemented by one or more components of the devices and systems of FIGS. 3-4. Although the present disclosure may describe certain steps of each process 500-1300 (and of other processes described herein) as being implemented by certain components of the devices and systems of FIGS. 3-4, this is for purposes of illustration only, and it should be understood that other components of the devices and systems of FIGS. 3-4 may implement those steps instead. For example, the steps of each process 500-1300 may be executed by server 404, 424 and/or by user equipment device 406, 407, AI agent 408, and/or by control circuitry 304 of a device 300, 301 and/or by control circuitry 411, 431.

FIG. 5 is a flowchart of an example process 500 for intercepting and modifying ML model inferencing, in accordance with an embodiment of the disclosure. In some embodiments, at step 502, control circuitry 431 receives, from user device 110, 112, or AI Agent (e.g., by way of an API), a selection (e.g., an in-segment selection) of a portion of an initial (e.g., original) ML model output (e.g., the segment) to be edited. Based on receiving the selection, control circuitry 431 may temporarily pause the inferencing process of ML model 140. In some embodiments control circuitry 431 preserves the context window data irrespective of the interception of the inferencing process of ML model 140.

In some embodiments, at step 504, control circuitry 431 may parse and tag the words within the selection of the portion of the ML model output. At step 506, control circuitry 431 may generate a plurality of logits (e.g., based on context window data) and identify the logits corresponding to the words in the selection. At step 508, control circuitry 431 may sort the logit output and determine top (e.g., top k or top p, or any number based on any suitable deterministic model) candidate token choices. Control circuitry 431 may implement various models for determining the top candidates, such as greedy sampling, top-k sampling, top-p (nucleus) sampling, or any other suitable model. At step 510, control circuitry 431 may present the identified top alternate token or tokens to user device 110, 112, or AI agent 120

In some embodiments, at step 512, control circuitry 431 receives, from user device 110, 112, or AI agent 120, an edit selection for modifying the initial ML model output. In some instances, the edit selection may be a selection from the list of top alternate tokens presented. In some instances, the edit selection may be a new entry provided by the user device 110, 112, or AI agent 120. Based on receiving the edit selection, control circuitry 431 may modify the initial ML model output (e.g., the original segment) by replacing the selected portion with the edit selection. At step 516, control circuitry 431 may cause the ML model to resume its inferencing process by feeding to ML model 140 the modified ML model output. At step 518, control circuitry 431 may cause ML model 140 may resume and perform inferencing based on the modified ML model output and context window data, and may present subsequent ML model output. At step 520, control circuitry 431 may determine whether additional portions (e.g., tokens) in the subsequent ML model output have been selected for processing. If so, the process returns to step 506. If not, then the process ends.

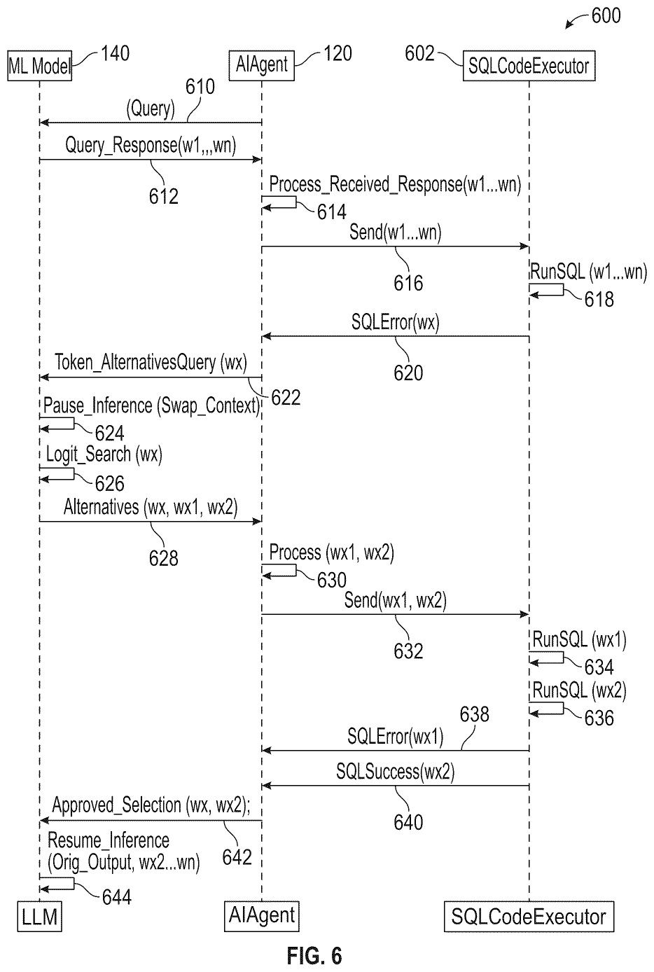

FIG. 6 is a system sequence diagram of an example process 600 of modifying ML model inferencing using an agentic workflow, in accordance with an embodiment of the disclosure. Although the example describes using the systems and methods in the context of an agentic workflow that queries a SQL database, it is understood that the example is for illustrative purposes and that the systems and methods described herein can be applied in any other suitable context for analyzing inferencing session output and data through other rule set, conditions, or programming. In some embodiments, at step 610, AI agent 120 transmits a query or prompt to ML model 140. At step 612, the query or prompt may cause ML model 140 to provide AI agent 120 with a query response (e.g., initial ML model output). The query response may include one or more output tokens (e.g., tokens {w1, . . . wn}). At step 614, AI agent 120 may process the received query response and, at step 616, send the output tokens (e.g., tokens {w1, . . . wn}) of the response to SQL code executor 602, which may run a programming or rules analysis, such as a SQL query, based on the tokens at step 618.

In some embodiments, at step 620, SQL code executor 602 may return a SQL error to AI agent 120 based on a particular token or tokens from the ML model output (e.g., token (wx)). At step 622, AI agent 120 may identify token (wx) as the cause of the SQL error and send a request to ML model 140 to intercept inferencing and to provide alternate tokens to token (wx).

In some embodiments, at step 624, AI agent 120 may instruct or otherwise cause ML model 140 to pause its inferencing based on the request for alternate tokens. In some instances, AI agent 120 may instruct ML model 140 to perform a GPU/CPU data swap operation and temporarily move the context data from the GPU to the CPU during the time period that ML model 140 inferencing is paused during interception. At step 626, ML model 140 may perform a search for a logit or logits corresponding to the token {wx} to be modified and determine the top candidate alternate tokens to token {wx}. At step 628, ML model 140 may provide the top alternate tokens (e.g., {wx, wx1, wx2}) to AI agent 120.

In some embodiments, at step 630, AI agent 120 processes the alternate tokens ({wx1, wx2}) (e.g., to integrate each alternate token into its workflow). At step 632, AI agent 120 may send the alternate tokens {wx1, wx2}, or a query based on the alternate tokens, to SQL code executor 602. At steps 634 and 636, SQL code executor 602 may run a programming or rules analysis, such as a SQL query, on each respective alternate token. At steps 638 and 640, SQL code executor 602 may return query results for each alternate token. For instance, at step 638, SQL code executor 602 may return an error message for alternate token (wx1). Meanwhile, at step 640, SQL code executor 602 may return a success message for alternate token (wx2).

In some embodiments, at step 642, AI agent 120 may select alternate token (wx2), based in part on the SQL query success message. AI agent 120 may send a request to ML model 140 to modify the original ML model output (e.g., query response {w1, . . . wn}) by replacing original token (wx) with the selected alternate token (wx2). At step 644, ML model 140 may update its original output (e.g., {w1, . . . wn}) with the modified output (e.g., {wx2, . . . wn}) and resume inferencing based on the updated output.

In some embodiments, ML model 140 determines that it has not received an alternate token selection (or a new token entry) from AI agent 120 within a certain period of time. In some instances, ML model 140 may then automatically resume inferencing. In other examples, ML model 140 may automatically consider the original output (e.g., query response {w1, . . . wn}) as final and discard the saved context data.

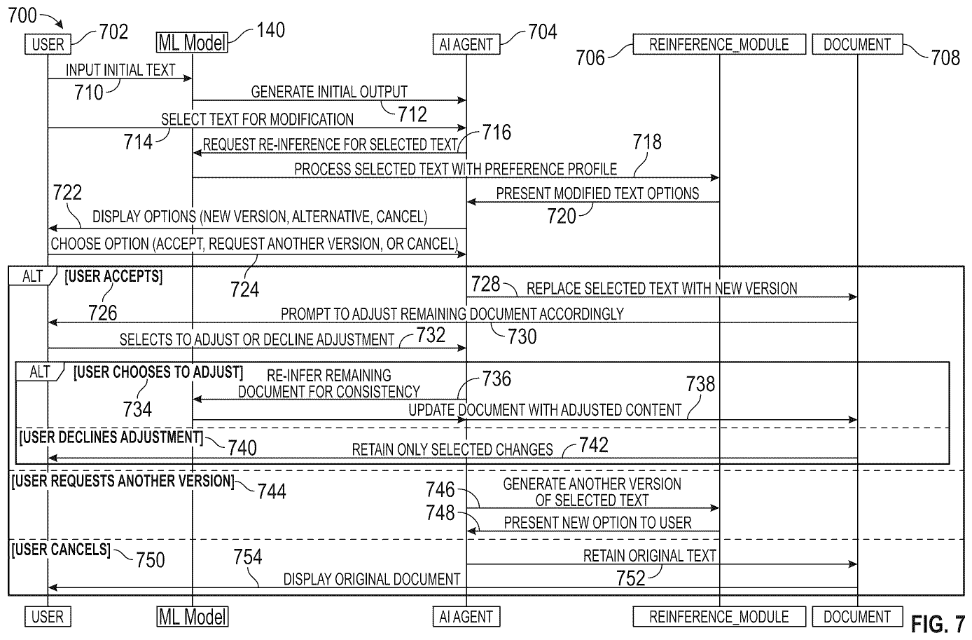

FIG. 7 is a system sequence diagram of an example process 700 of iterative ML model inferencing of previously inferenced output, in accordance with an embodiment of the disclosure. User 702 may be associated with user device 110, 112 of FIG. 1. In an embodiment, AI agent 704 may be associated with AI agent 120 of FIG. 1. ML model 140 may comprise re-inference module 706. In some embodiments, one or more functions corresponding to ML model 140, re-inference module 706, and/or document 708 are performed by ML model 140, AI agent 704, or both. In an embodiment, functionality and/or other components of AI agent 704 and ML model 140 are combined into the same AI agent system of AI agent 704. Illustratively, document 708 may comprise a structured document interface, such as a word-processing document, an HTML page, a PDF file, chat or messaging interface, or any other suitable interface. For instance, document 708 may comprise a tax form. Alternatively, in some instances, one or more documents 708 may comprise one or more fields in a tax form. Although the example describes using the systems and methods for iteratively inferencing ML model output to provide re-inferenced output via a structured document interface, it is understood that the systems and methods described herein can be applied in any other suitable framework.

In some embodiments, at step 710, user 702 provides (e.g., by way of AI agent 704) an initial input text to ML model 140. Based on the input text, at step 712, AI agent 104 may cause ML model 140 to generate and provide an initial output

In some embodiments, at step 714, AI agent 704 may prompt user 702 to select text from the initial output for modification. At step 716, AI agent 704 may send to ML model 140 a request to iterate inferencing (e.g., re-inferencing) for the selected text. The request to iterate inferencing may cause ML model 140 to pause inferencing and save the context data of the current session.

At step 718, AI agent 704 (e.g., via the request to iterate inferencing) may instruct ML model 140 to process (e.g., by way of re-inference module 706) the selected text with user profile or user preference data of user 702 (or of a user associated with AI agent 704), or any other suitable supplemental context data. At step 720, AI agent 704 may cause re-inference module 706 toto present modified text options corresponding to the selected text. The options may include alternate versions of the selected text based on modifying the text directly, one or more parameters, attributes, other suitable characteristics associated with the selected text, or a combination thereof. For instance, the options may include a new version of the selected text, one or more alternative versions of the selected text, or canceling the request. At step 722, AI agent 704 may display these options to user 702. In some instances, AI agent 704 may also present a preview of each option. At step 724, user 702 may choose an option (e.g., accept a particular alternate version of the selected text, request another version, or cancel or close display of the options).

In some embodiments, at step 726, if user 702 accepts the particular alternate version of the selected text, then, at step 728, AI agent 704 modifies document 708 by replacing the selected text with the new version (e.g., resulting in an adjusted selected text). At step 730, AI agent 704 may prompt user 702 with selectable options to adjust other portions of document 708. At step 732, user 702 may select one of those options (e.g., adjust additional text portions or decline adjustment).

In some embodiments, at step 734, user 702 chooses to make further adjustments to the document 708 (e.g., to further adjust the same initial selected text again or adjust additional portions of the document 708). At step 736, AI agent 704 instructs ML model 140 to re-infer the adjusted selected text or other portions of the text. For instance, AI agent 704 may instruct ML model 140 to re-infer the remainder of document 708 to check for consistency with the adjusted selected text (e.g., same or similar style, tone, level of detail, audience, other suitable parameter or attribute, or a combination thereof). If one or more parameters or attributes of the remainder of document 708 is inconsistent with that of the adjusted selected text, then AI agent 704 may instruct ML model 140 to update 738 the remainder of document 708 with adjusted content accordingly, such that the remainder of document 708 and the adjusted selected text are consistent with each other.

In some embodiments, at step 740, user 702 declines to make further adjustments to document 708. In response, at step 742, AI agent 704 may cause document 708 to only retain the initially selected changes (e.g., only the initial selected text would be adjusted, while the original version of the remainder of the document 708 is maintained).

Additionally, or alternatively, at step 744, user 702 requests another version of the selected text. At step 746, AI agent 704 may cause ML model 140 to generate the requested version of the selected text. AI agent 704 may provide the new options (e.g., accept this requested version, request yet another version, or cancel request for this version) to user 702 at step 748.

At step 750, if user 702 selects to cancel adjusting the selected text, then at step 752, AI agent 704 may cause document 708 to retain its original text, which is presented to user 702 at step 754.

In some embodiments, ML model 140 collects and learns from data associated with behavior of the user 702 and/or AI agent 704, such as selecting certain text portions for modification, the types of adjustments made to various text portions of document 708, and the canceling options to adjust other text portions of document 708. Based on the learning, ML model 140 may progressively adapt its inferencing to the user preferences.

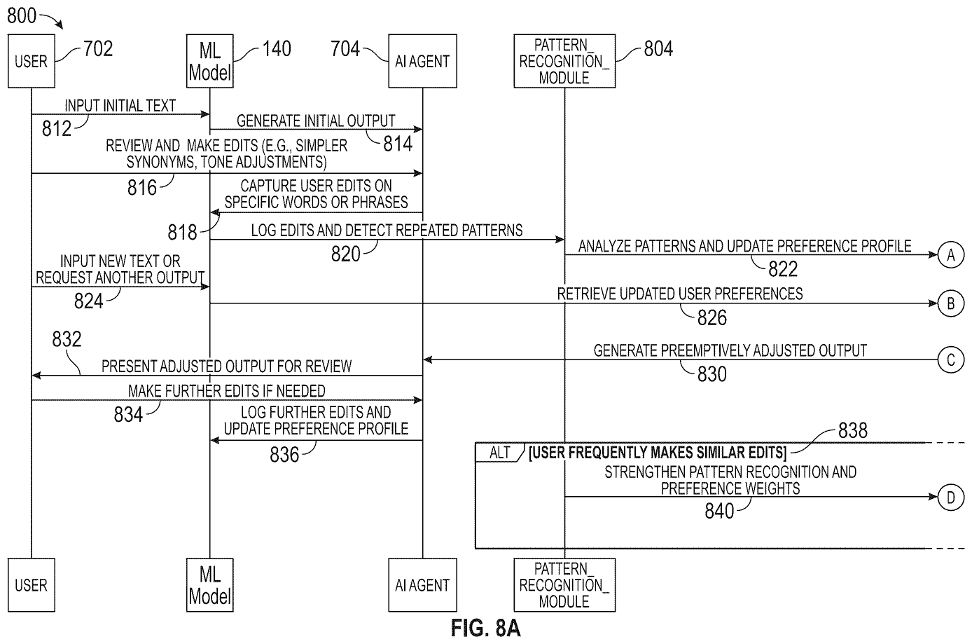

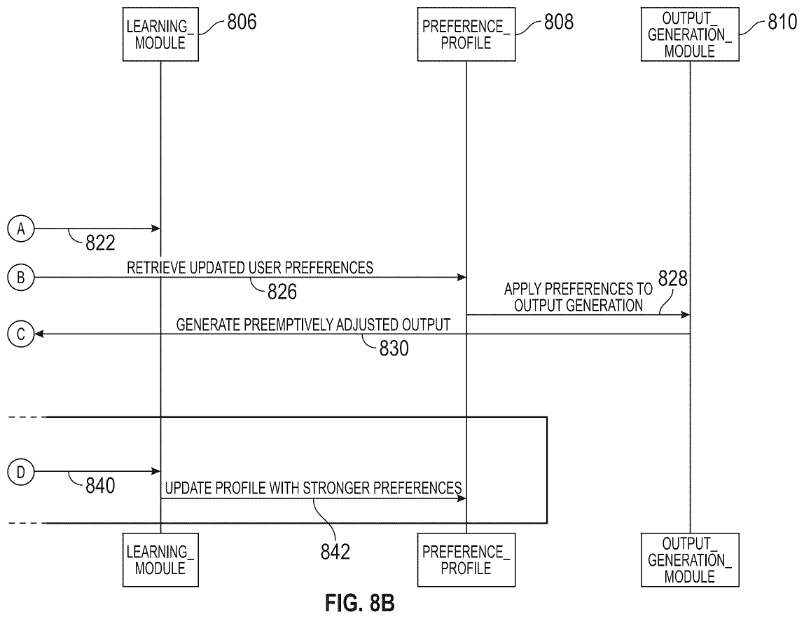

FIGS. 8A and 8B are system sequence diagrams of an example process 800 for modifying ML model inferencing based on pattern recognition, in accordance with an embodiment of the disclosure. In the example, ML model 140 may progressively adapt to user preferences based on learning from user edits of ML model output. For instance, if user 702 frequently changes specific words to simpler synonyms or adjusts the tone of ML model output, AI agent 704 may instruct ML model 140 to detect these patterns and to preemptively suggest similar modification in subsequent ML model outputs. Adapting inferencing to such detected user preferences can help reduce the number of edits needed in text generation by aligning initial inferences closer to user preferences. In some embodiments, one or more functions corresponding to pattern recognition module 804, learning module 806, output generation module 810, or ML model 140 are performed by ML model 140, AI agent 704 (e.g., AI agent 120) or both. Although the example describes using the systems and methods in the context of modifying outputs within a structured document interface, it is understood that the systems and methods described herein can be applied in any other suitable framework.

In some embodiments, at step 812, user 702 provides (e.g., by way of AI agent 704) a first input or prompt (e.g., initial input text) to ML model 140. At step 814, AI agent 704 may instruct ML model 140 to generate an initial output based on or responsive to the first input.

In some embodiments, at step 816, user 702 reviews and makes edits to one or more portions of the initial ML model output. For instance, user 702 may replace various words with alternate words (e.g., simpler synonyms, domain specific language), adjust the tone, adjust style for a certain audience or modify any other suitable parameters or attributes of the initial ML model output. At step 818, AI agent 704 captures and transmits the user edits to ML model 140.

In some embodiments, ML model 140 comprises pattern recognition module 804, learning module 806, and output generation module 810. At step 820, AI agent 704 may instruct ML model 140 to log the received edits and to detect repeated patterns. For instance, ML model 140 may use any suitable pattern recognition technique to detect one or more patterns associated with the user edits. At step 822, pattern recognition module 804 may analyze the detected patterns and update user preferences (e.g., preference profile 808) of user 702 based on the pattern analysis data.

In some embodiments, at step 824, user 702 provides (e.g., by way of AI agent 704) a second input (e.g., input new text or request another ML model output) to ML model 140. Based on receiving the second input, at step 826, AI agent 704 causes ML model 140 to retrieve the updated user preferences associated with user 702 (e.g., corresponding to preference profile 808). At step 828, the updated user preferences are applied to output generation module 810, which may automatically generate a suggested adjusted output based on the updated user preferences at step 830. At step 832, AI agent 704 presents for recommendation the suggested adjusted output.

In some embodiments, at step 834, user 702 may make further edits to the suggested adjusted output. AI agent 704 may cause ML model 140 to log these further edits and to further update preference profile 808 based on patterns detected in the further edits.

In some embodiments, at step 838, AI agent 704 instructs pattern recognition module 804 to detect whether user 702 has frequently made similar edits. For instance, user 702 may have made a certain number of the same or similar type of edits consecutively or over a particular period of time. In some instances, user 702 may have made the same type of edits specifically for a certain type of document, such as a research paper or a web blog post. At step 840, based on detecting edit patterns having high frequency, AI agent 704 may instruct pattern recognition module 804 to strengthen pattern recognition and preference weights for these types of edits. At step 842, AI agent 704 may instruct learning module 806 to update preference profile 808 with these stronger preferences or weights.

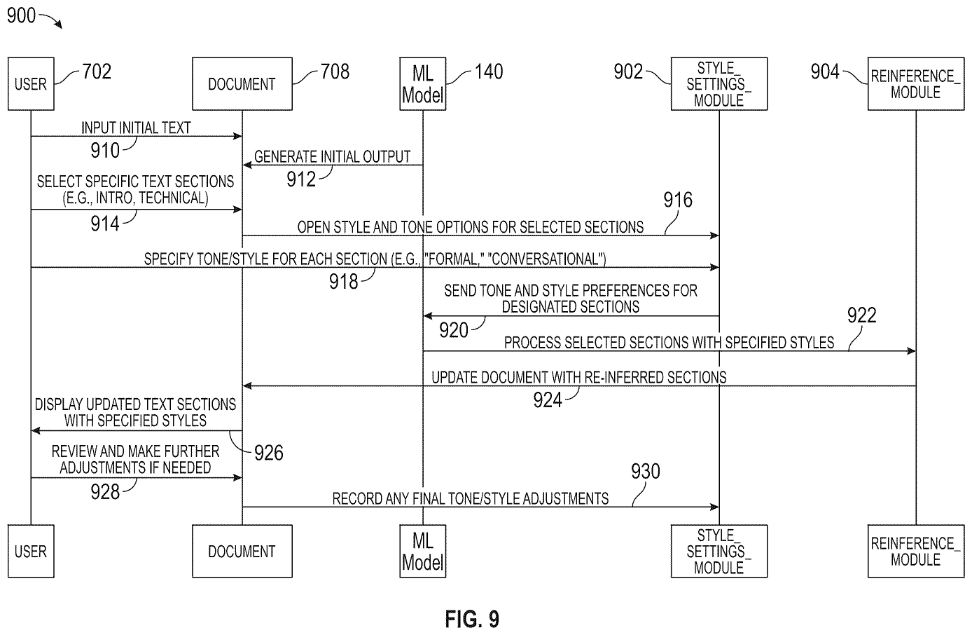

FIG. 9 is a system sequence diagram of an example process 900 for modifying ML model inferencing based on various parameters or attributes, in accordance with an embodiment of the disclosure. In some embodiments, user 702 could specify certain configuration of various parameters or attributes (e.g., style settings, tone settings) for one or more portions of ML model output (e.g., specific document sections) before ML model 140 re-inferences the ML model output. For instance, instead of specifying global tone settings, user 702 may designate portions of a text document (e.g., introductory paragraphs, technical descriptions) to have distinct stylistic features (e.g., formal, conversational, or simplified). AI agent 704 (as illustrated in FIGS. 7 and 8) may then cause ML model 140 to re-infer each section to match the assigned tone, allowing for more control across different parts of the ML model output. In some embodiments, one or more functions corresponding to style and settings module 902, re-inference module 904, or ML model 140 are performed by ML model 140, AI agent 704 (e.g., AI agent 120) or both. Although the example describes using the systems and methods in the context of modifying documents, it is understood that the systems and methods described herein can be applied in any other suitable context.

In some embodiments, at step 910, user 702 provides (e.g., by way of AI agent 704) an initial input (e.g., initial text) into document 708. At step 912, AI agent 704 causes ML model 140 to generate an initial output based on the initial input.

In some embodiments, ML model 140 comprises style and settings module 902 and re-inference module 904. At step 914, user 702 may select specific text sections (e.g., introduction, technical sections) for modification. At step 916, AI agent 704 may present a list of options for modifying parameters or attributes (e.g., provided by style and settings module 902 or any other suitable module).

In some embodiments, at step 918, user 702 selects a particular value or quality for a parameter or attribute for each parameter or attribute option. For instance, user 702 may select a formal tone for the tone parameter, a conversational style for the style parameter, or other suitable parameter relating to domain specific language or subject matter jargon. At step 920, AI agent 704 may instruct style and settings module 902 to send the tone and style preferences for the designated sections to ML model 140, and AI agent 704 may instruct ML model 140 to process the selected sections with the specified styles at step 922. At step 924, AI agent 704 may instruct re-inference module 904 to update document 708 with the re-inferred sections and the updated text sections with the specified styles may be displayed at step 926.

In some embodiments, at step 928, user 702 may review the updated text sections and make further adjustments. At step 930, AI agent 704 may instruct ML model 140 to classify the types of further adjustments made (e.g., identify the parameters or attributes associated with the further adjustments) and to record these adjustments (e.g., to style and settings module 902).

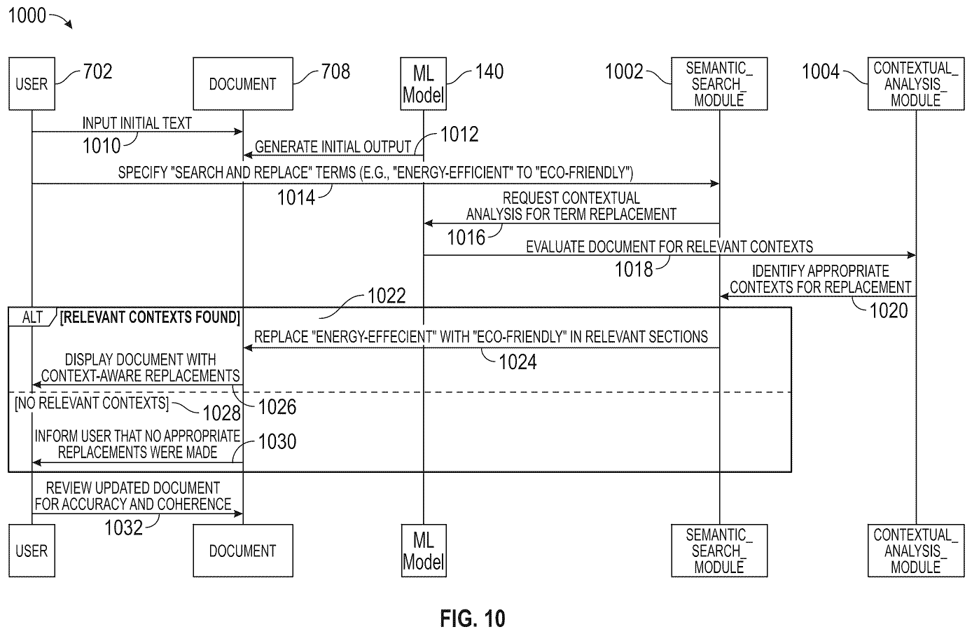

FIG. 10 is a system sequence diagram of another example process 1000 for modifying ML model inferencing based on various parameters or attributes, in accordance with an embodiment of the disclosure. In some embodiments, user 702 (e.g., by way of AI Agent 120 or 704) can specify a particular token (e.g., concept, term, phrase) to replace with an alternate token across the entire document 708, but only in relevant contexts. For example, user 702 may request to replace the token “energy-efficient” with “eco-friendly.” However, ML model 140 may only make the substitution in contexts where the replacement is semantically appropriate, ensuring contextual coherence throughout the document 708. In some embodiments, one or more functions corresponding to semantic search module 1002, contextual analysis module 1004, or ML model 140 are performed by ML model 140, AI agent 704 (e.g., AI agent 120, or as illustrated in FIGS. 7 and 8), or both. Although the example describes using the systems and methods in the context of modifying documents, it is understood that the systems and methods described herein can be applied in any other suitable context.

In some embodiments, at step 1010, user 702 provides (e.g., by way of AI agent 704) initial input (e.g., initial text). Based on the initial text, at step 1012, AI agent 704 may instruct ML model 140 to generate an initial output for document 708. At step 1014, user 702 may request to replace a particular token or tokens with one or more alternate tokens.

In some embodiments, ML model 140 comprises semantic search module 1002 and contextual analysis module 1004. At step 1016, AI agent 704 may instruct semantic search module 1002 to request contextual analysis for the token replacement. At step 1018, AI agent 704 may instruct ML model 140 to evaluate document 708 for relevant contexts. At step 1020, AI agent 704 may instruct contextual analysis module 1004 to identify appropriate contexts for token replacement. For instance, contextual analysis module 1004 may use metadata associated with document 708, user profile and/or user history data, any other suitable supplemental contextual data, classification model, semantic analysis model, any other suitable deterministic model, or a combination thereof for identifying one or more contexts associated with document 708.

In some embodiments, at step 1022, if one or more relevant contexts are detected, then at step 1024, AI agent 704 may instruct semantic search module 1002 may replace the specified token with the alternate token (e.g., replace instances of “energy-efficient” with “eco-friendly”) in the relevant sections of document 708. The updated document 708 with context-aware replacements may be displayed at step 1026.

In some embodiments, at step 1028, if no relevant contexts are detected, then at step 1030, a notification may be sent to user 702 notifying the user 702 of the same.

In some embodiments, at step 1032, user 702 continues to review the updated document 708 for accuracy and coherence.

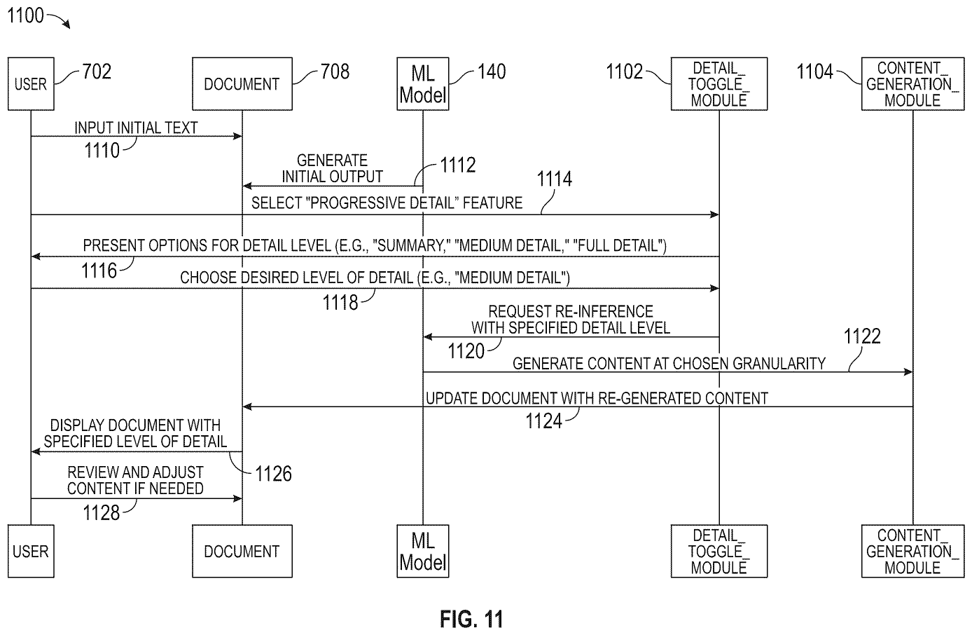

FIG. 11 is a system sequence diagram of yet another example process 1100 for modifying ML model inferencing based on various parameters or attributes, in accordance with an embodiment of the disclosure. In some embodiments, AI agent 704 (as illustrated in FIGS. 8 and 9) instructs ML model 140 to re-inference and to regenerate its output at different levels of detail (e.g., high-level summaries, medium detail, or full detail) based on a requested level of granularity. In some embodiments, one or more functions corresponding to detail toggle module 1102 or content generation module 1104 are performed by ML model 140, AI agent 704 (e.g., AI agent 120) or both. Although the example describes using the systems and methods in the context of modifying documents, it is understood that the systems and methods described herein can be applied in any other suitable context.

In some embodiments, ML model 140 comprises detail toggle module 1102 and content generation module 1104. At step 1110, user 702 may provide (e.g., by way of AI agent 704) initial input (e.g., initial text). Based on the initial text, at step 1112, ML model 140 generates an initial output for document 708. At step 1114, user 702 may request to modify the granularity, or other suitable parameter or attribute, of document 708 (e.g., by selecting or toggling an option to adjust the parameter or attribute). At step 1116, AI agent 704 may instruct detail toggle module 1102 to present options for alternative levels of detail (e.g., summary, medium detail, full detail).

In some embodiments, at step 1118, user 702 selects a level of detail with which to modify one or more portions of document 708. At step 1120, AI agent 704 may instruct detail toggle module 1102 to request ML model 140 to re-inference its initial output with the specified level of detail. At step 1122, AI agent 704 may cause ML model 140 may re-generate the content (e.g., the modified output) at the specified level of detail. At step 1124, AI agent 704 may instruct content generation module 1104 to update document 708 with the re-generated content. At step 1126, AI agent 704 may cause ML model 140 to display the document with the specified level of detail. At step 1128, user 702 may continue to review and adjust document 708 as needed.

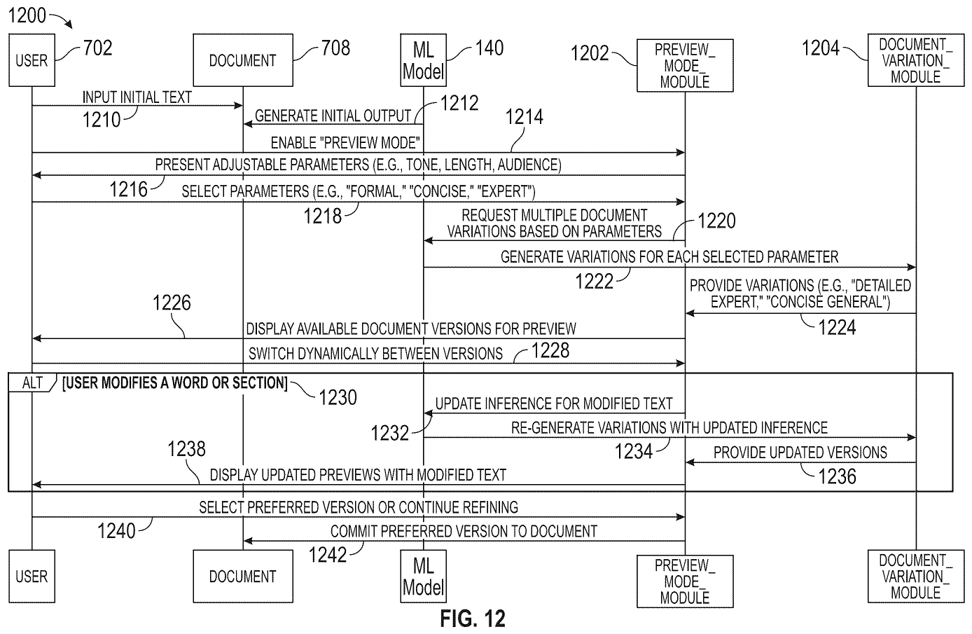

FIG. 12 is a system sequence diagram of an example process 1200 for providing previews of alternate ML model inferencing outputs, in accordance with an embodiment of the disclosure. In some embodiments, AI agent 704 (as illustrated in FIGS. 8 and 9) may instruct ML model 140 to generate, for display, previews of potential alternate versions of document 708 based on adjustable parameters or attributes. User 702 may dynamically switch between the previews. For example, AI agent 704 may instruct ML model 140 to generate multiple variations of document 708 based on the selected parameters, attributes, other suitable supplemental contextual data, or a combination thereof. For instance, different variations of document 708 can be generated for preview, based on adjusting one or more parameters for tone (e.g., formal, casual), length (e.g., detailed, concise), or audience (e.g., expert, general public). When user 702 selects a particular preview of a version of document 708, ML model 140 generates and provides a full version of the document 708 under the adjusted parameters or attributes corresponding to the selected preview. User 702 may also continue to edit the selected version of the document 708. In some examples, changes in a particular word in document 708 may be dynamically reflected in the previews of each corresponding version (e.g., each preview reflects the updated inference from changing the particular word). In some embodiments, one or more functions corresponding to preview mode module 1202 or document variation module 1204 are performed by ML model 140, AI agent 704 (e.g., AI agent 120) or both. Although the example describes using the systems and methods in the context of modifying documents, it is understood that the systems and methods described herein can be applied in any other suitable context.

In some embodiments, ML model 140 comprises preview mode module 1202 and document variation module 1204. At step 1210, user 702 may provide (e.g., by way of AI agent 704) initial input (e.g., initial text). Based on the initial text, at step 1212, AI agent 704 may instruct ML model 140 to generate an initial output for document 708. At step 1214, user 702 may request to enable a preview mode of document 708 to view previews of different potential versions of document 708 under different parameters or attributes. At step 1216, AI agent 704 may instruct preview mode module 1202 may present user 702 with a set of alternate adjustable parameters (e.g., tone, length, audience) and values (e.g., formal or causal for tone; detailed or concise for length; expert or general public for audience).

In some embodiments, at step 1218, user 702 selects values for one or more adjustable parameters (e.g., formal for tone; concise for length; and expert for audience). In some embodiments, user 702 can enter their own parameters or parameter values not presented in the options. For instance, user 702 may enter a new parameter for geographic language and a parameter value of American English. At step 1220, AI agent 704 may instruct preview mode module 1202 to send to ML model 140 the request to adjust parameters, and, at step 1222, AI agent 704 may cause ML model 140 to generate multiple document variations based on the selected parameters. At steps 1224 and 1226, AI agent 704 may provide the different previews (e.g., version) for display, allowing for user 702 at step 1228 to switch dynamically between the different previews.

In some embodiments, at step 1230, user 702 may modify one or more tokens (e.g., a word or section) of document 708. At step 1232, AI agent 704 may instruct preview mode module 1202 may update inferencing for the modified text of document 708. At step 1234, AI agent 704 may instruct ML model 140 to regenerate variations of document 708 based on the updated inference. At steps 1236 and 1238, AI agent 704 may provide updated previews with the modified text for display.

In some embodiments, at step 1240, user 702 can select a preferred version from the previews or continue refining the updated document 708. At step 1242, AI agent 704 may instruct preview mode module 1202 to commit the selected preferred version to document 708.

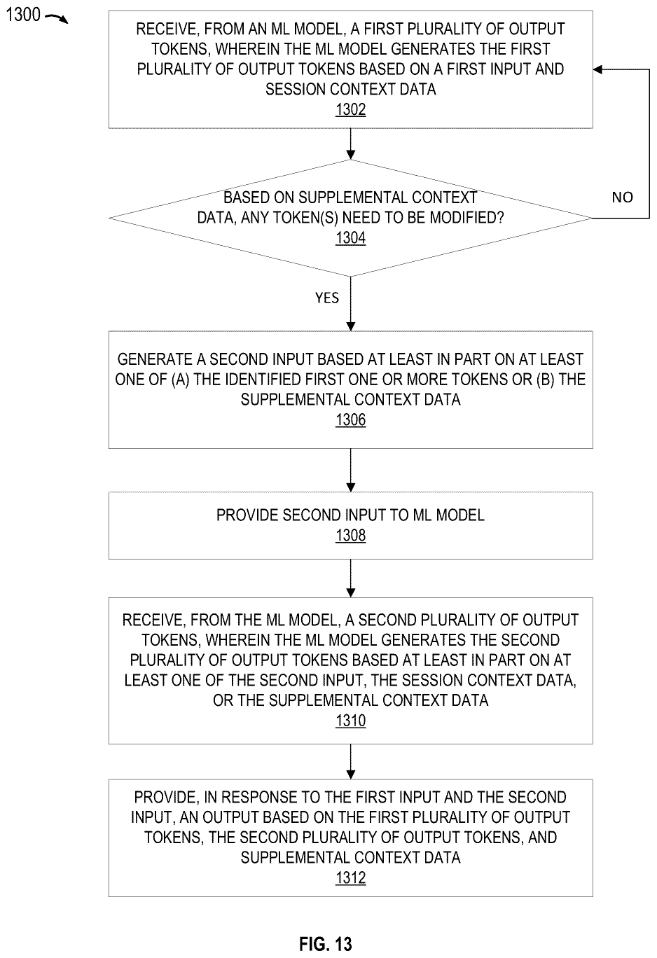

FIG. 13 is a flowchart of another example process 1300 for modifying ML model inferencing, in accordance with an embodiment of the disclosure. In some embodiments, at step 1302, control circuitry 304 receives, from an ML model (e.g., corresponding to ML model 140 of FIG. 1) a first plurality of output tokens. The first plurality of output tokens may be generated by the ML model based on a first input (e.g., from control circuitry 304) and context data of the ML model session.

In some embodiments, at step 1304, control circuitry 304 determines, based on supplemental context data, whether any tokens from the first plurality of output tokens need to be modified. If so, the process continues to step 1306. If not, the process reverts to step 1302.

In some embodiments, at step 1306, control circuitry 304 generates a second input for ML model. The second input may be based at least in part on the identified tokens to be modified, the supplemental context data, or both.

In some embodiments, at step 1308, control circuitry 304 provides the second input to the ML model.

In some embodiments, at step 1310, control circuitry 304 receives, from the ML model, a second plurality of output tokens. This second plurality of output tokens may be generated by the ML model based on the second input, the session context data, the supplemental context data, or a combination thereof. At step 1312, in response to the first input and the second input, control circuitry 304 provides an output based on the first plurality of output tokens, the second plurality of output tokens, and supplemental context data.

The processes discussed above are intended to be illustrative and not limiting. One skilled in the art would appreciate that the steps of the processes discussed herein may be added, omitted, modified, combined and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

Throughout the specification, the phrases “in response to” and “based on” shall be understood to have a broad meaning unless context requires otherwise. For example, “in response to” can refer to a step or process that is in direct or indirect response to a prior or other step, and “based on” can refer to a step that is based at least in part on a prior or other step.

1. A method comprising:
receiving, from a machine learning (ML) model, a first plurality of output tokens, wherein the ML model generates the first plurality of output tokens based on a first input and session context data;
based on supplemental context data, identifying, from the first plurality of output tokens, a first one or more tokens to be modified;
generating a second input based on at least one of (a) the identified first one or more tokens, or (b) supplemental context data, wherein the second input comprises a modification of at least a portion of the first input;
providing, to the ML model, the second input;
receiving, from the ML model, a second plurality of output tokens, wherein the ML model generates the second plurality of output tokens based on at least one of the second input, session context data, or supplemental context data; and
providing, in response to the first input and the second input, an output based on the first plurality of output tokens, the second plurality of output tokens, and supplemental context data.

2. The method of claim 1, wherein the supplemental context data comprises at least one of one or more parameters associated with session context data, modification of the one or more parameters, one or more attributes associated with the first token or the first plurality of output tokens, modification of the one or more attributes, data associated with one or more user profiles, user input, or context data associated with one or more other sessions.

3. The method of claim 2, wherein the one or more attributes comprise at least one of terms or phrases, tone, length, language style, audience, or level of detail.

4. The method of claim 1:
wherein the ML model generates a plurality of candidate output tokens based on the first input and session context data, and wherein the plurality of candidate output tokens comprises the first one or more tokens and a plurality of alternate output tokens;
wherein the ML model generates a plurality of logits corresponding to the plurality of candidate output tokens, wherein the ML model identifies a subset of logits of the plurality of logits, and wherein the ML model determines the first one or more tokens and the plurality of alternate output tokens based on the identified subset of logits;
and wherein the method further comprises:
receiving, from the ML model, the plurality of alternate output tokens; and
selecting one or more alternate output tokens from the plurality of alternate output tokens based on the supplemental context data; and
wherein generating the second input is further based on the selected one or more alternate output tokens.

5. The method of claim 4:
wherein the ML model comprises a transformer neural network; and
wherein different logits of the plurality of logits are generated at different layers of the transformer neural network.

6. The method of claim 4, wherein the subset of logits of the plurality of logits is identified based on:
transforming the plurality of logits into a probability distribution; and
selecting a number of logits with the highest probabilities in the probability distribution.

7. The method of claim 4, wherein the subset of logits of the plurality of logits is identified based on one or more of greedy sampling, top-k sampling, or top-p sampling of the plurality of logits.

8. The method of claim 4:
wherein a respective alternate output of a plurality of alternate outputs is generated based on a corresponding alternate output token of the plurality of alternate output tokens and session context data;
the method further comprises receiving a preview of each alternate output of the plurality of alternate outputs;
wherein the generating the second input is further based on selecting an alternate output token corresponding to a particular preview of a respective alternate output; and
wherein the ML model generates the second plurality of output tokens further based on selected alternate output token.

9. The method of claim 4, wherein generating the second input is further based at least in part on providing, to the ML model, a token not included in the plurality of alternate output tokens.

10. The method of claim 1, further comprising:
providing, to the ML model, a request to omit the first one or more tokens from session context data.

11. The method of claim 1, wherein session context data is stored in a graphics processing unit (GPU) associated with the ML model;
wherein session context data is moved from the GPU to a central processing unit (CPU) associated with the ML model at a time after the first input is provided to the ML model and before the second input is provided to the ML model; and
wherein session context data is moved from the CPU to the GPU when the second input is provided to the ML model.

12. The method of claim 1, wherein generating the second input is further based at least in part on determining that an error occurs in an at least one of an agentic workflow or a programmatic application programming interface (API) associated with utilizing the first one or more tokens.

13. A system comprising:
input/output circuitry configured to:
receive, from a machine learning (ML) model, a first plurality of output tokens, wherein the ML model generates the first plurality of output tokens based on a first input and session context data;
control circuitry configured to:
based on supplemental context data, identify, from the first plurality of output tokens, a first one or more tokens to be modified;
generate a second input based on at least one of (a) the identified first one or more tokens, or (b) supplemental context data, wherein the second input comprises a modification of at least a portion of the first input;
provide, to the ML model, the second input;
receive, from the ML model, a second plurality of output tokens, wherein the ML model generates the second plurality of output tokens based on at least one of the second input, session context data, or supplemental context data; and
provide, in response to the first input and the second input, an output based on the first plurality of output tokens, the second plurality of output tokens, and supplemental context data.

14. The system of claim 13, wherein the supplemental context data comprises at least one of one or more parameters associated with session context data, modification of the one or more parameters, one or more attributes associated with the first token or the first plurality of output tokens, modification of the one or more attributes, data associated with one or more user profiles, user input, or context data associated with one or more other sessions.

15. The system of claim 14, wherein the one or more attributes comprise at least one of terms or phrases, tone, length, language style, audience, or level of detail.

16. The system of claim 13:
wherein the ML model generates a plurality of candidate output tokens based on the first input and session context data, and wherein the plurality of candidate output tokens comprises the first one or more tokens and a plurality of alternate output tokens;
wherein the ML model generates a plurality of logits corresponding to the plurality of candidate output tokens, wherein the ML model identifies a subset of logits of the plurality of logits, and wherein the ML model determines the first one or more tokens and the plurality of alternate output tokens based on the identified subset of logits;
wherein the control circuitry is further configured to:
receive, from the ML model, the plurality of alternate output tokens; and
select one or more alternate output tokens from the plurality of alternate output tokens based on the supplemental context data; and
wherein generating the second input is further based on the selected one or more alternate output tokens.

17. The system of claim 16:
wherein the ML model comprises a transformer neural network; and
wherein different logits of the plurality of logits are generated at different layers of the transformer neural network.

18. The system of claim 16, wherein the subset of logits of the plurality of logits is identified based on:
transforming the plurality of logits into a probability distribution; and
selecting a number of logits with the highest probabilities in the probability distribution.

19. The system of claim 16, wherein the subset of logits of the plurality of logits is identified based on one or more of greedy sampling, top-k sampling, or top-p sampling of the plurality of logits.

20. The system of claim 16:
wherein a respective alternate output of a plurality of alternate outputs is generated based on a corresponding alternate output token of the plurality of alternate output tokens and session context data;
wherein the control circuitry is further configured to:
receive a preview of each alternate output of the plurality of alternate outputs;
wherein the generating the second input is further based on selecting an alternate output token corresponding to a particular preview of a respective alternate output; and
wherein the ML model generates the second plurality of output tokens further based on selected alternate output token.

21-36. (canceled)
